(19) United States
(12) Patent Application Publication
(10) Pub. No.: US 2025/0316144 A1
(43) Pub. Date: Oct. 9, 2025

(54) METHOD AND SYSTEM FOR SOCIAL CONTESTS

(71) Applicant: Byron LAMBERT, Longbot Key, FL (US)

(72) Inventor: Byron LAMBERT, Longbot Key, FL (US)

(21) Appl. No.: 19/241,915

(22) Filed: Jun. 18, 2025

Related U.S. Application Data
(63) Continuation-in-part of application No. 17/865,996, filed on Jul. 15, 2022.

(51) Int. Cl. G07F 17/32; G06Q 50/00

(52) U.S. Cl. CPC G07F 17/3276; G06Q 50/01; G07F 17/323; G07F 17/3288; G07F 17/3237

(57) ABSTRACT

A method and system for social contests. The method and system include an application for social contests that allows new social contests to be created for private and public groups of people. An administrator of a social contest creates a unique new social contest or selects from plural pre-determined social contests. Participants join the social contests with a QR code, a push message or an invite from a social media site. Participants in the social contest invite their friends to participate in the social contest and participants can message each other directly during the social contest. A graphical user interface is presented on the application to allow creation and administration of the social contests.

### CROSS REFERENCES TO RELATED APPLICATION

This utility patent application is a continuation-in-part (CIP) of U.S. patent application Ser. No. 17/865,996, filed Jul. 15, 2022, now abandoned.

### FIELD OF INVENTION

This application relates to online electronic contests. More specifically, it relates to a method and system for social contests.

### BACKGROUND OF THE INVENTION

There are a number of ways for a group of people to engage in a social contest. The group of people can engage in a social contest via email, text, social media applications such as FACEBOOK, TWITTER/X, etc.

A group of people can also engage in a social contest manually by creating a social contest on paper such a “football pool” where a grid is drawn and users select squares representing a number of points that will be scored for each quarter, at the end of a game, etc.

There are a number problems associated with creating and participating in social contests. One problem is that there is application or tool to create a desired social contest.

Another problem is that there no easy way for a coordinator of a social contest to create a new desired social contest.

Another problem is that there is no easy way for a coordinator of a social contest to invite a number of users to participate in the desired social contest that has been created by the administrator.

Another problem is that there is no easy way for users who are participating in a social contest to invite their friends and have the coordinator of the social contest manage the new invites.

Another problem is that there is no easy way for participants in a social contest to directly message each other during a social contest.

There have been some attempts to solve some of the problems associated with social contests including for television, video games, football pools, etc.

For example, U.S. Pat. No. 11,127,043 that issued to Khare, et al. teaches “The embodiments herein provide a system and a method for enhancing audience reach and brand promotion in social media marketing by including social media messages like Twitter messages into television channels. The method effectively promotes brands, sale offers, discount deals, and social contests to the people who are beyond internet's reach. The system automatically collects Twitter, messages posted by the users and telecasts the messages on selected TV channels as banners while viewers watch programs on TV. The system generates positive brand awareness among people by telecasting the tweets having the most positive reviews about a particular brand or event. The system detects and telecasts the most relevant tweets of a particular event or a brand using hashtags created in the tweets for brands or event names.”

U.S. Pat. No. 10,949,325 that issued to Culibrk, et al. teaches “Embodiments disclosed herein include a system that is capable of processing test data across multiple sessions of a video game. In some cases, the tests are performed over multiple video games that share a game engine. The generated test data may be analyzed as the test is being performed and key performance indicators may be extracted from the test data reducing the test data by at least an order of magnitude. Further, the extracted key performance indicators are used to automatically conduct further testing, such as regression testing, based on an analysis of the key performance indicators with respect to trend data generated from prior tests of the video game or of a shared game engine used by multiple video games.”

U.S. Pat. No. 10,909,813 that issued to Maggio teaches “A system and method are provided for implementing a uniquely automated, and otherwise gamified, version of a Squares Game, enhanced with additional reactive gaming schemes and with an opportunity for expansion to an active wagering scenario. The disclosed schemes incorporate technology for hosting on, or interacting/reacting with, potential participants' mobile and personal communicating and computing devices. The disclosed systems and methods uniquely adapt the gamified Squares Game to implement hybrid schemes employed by one or more of the myriad “fantasy sports” leagues that have become attractive to mass audiences. The disclosed schemes provide event-long score tabulation as a mechanism by which to allocate awards. The disclosed schemes provide for branding to certain sponsors of a Super Squares event, league, or season, in a manner that the sponsoring entity's retail and/or website properties may be linked to the automated game in order to facilitate increased traffic, sales and/or exposure.”

U.S. Pat. No. 10,596,468 that issued to Maggio teaches “A system and method are provided for implementing a uniquely automated, and otherwise gamified, version of a Squares Game. The disclosed schemes incorporate technology for hosting on, or interacting/reacting with, potential participants' mobile and personal communicating and computing devices. The disclosed systems and methods uniquely adapt the gamified Squares Game to implement hybrid schemes employed by one or more of the myriad “fantasy sports” leagues that have become attractive to mass audiences. The disclosed schemes provide event-long score tabulation as a mechanism by which to allocate awards. The disclosed schemes provide for branding to certain sponsors of a Super Squares event, league, or season, in a manner that the a sponsoring entity's retail and/or website properties may be linked to the automated game in order to facilitate increased traffic, sales and/or exposure.”

U.S. Pat. No. 10,297,115 that issued to Maggio teaches “A system and method are provided for implementing a uniquely automated, and otherwise gamified, version of a Squares Game. The disclosed schemes incorporate technology for hosting on, or interacting/reacting with, potential participants' mobile and personal communicating and computing devices. The disclosed schemes simplify hosting of, and participation in, a unique implementation of a Squares Game associated with one or more live event, including but not limited to live sporting events. The disclosed schemes introduce a streamlined process for registering participants, selecting interior game squares, among many players, and executing all of the gaming functions in an automated manner to include identification and notification of winners when their winning numbers are determined to be associated with respective numbers in the live event.”

U.S. Published patent application No. 20190279467 published by Saunders teaches “The present disclosure provides systems and methods of the play of skill-based games of squares that maintains player engagement, and in contrast to existing sports fan games, provide opportunities for less avid sports fans to participate enjoyably. In accordance with aspects and embodiments, weighted point values are assigned to squares based on the desirability of the squares. In certain cases, the desirability of squares may be determined by a computerized system having a central hub and processor in communication with players via the internet.”

U.S. Published patent application No. 20140274332 published by Carlin teaches “Systems and methods can support an automated wagering system. The system can specify a payout scenario. The system can specify a number of wager options. The system can assign outcomes of the specified payout scenario to each of the specified number of wager options. The system can receive one or more wagers, from one or more users, each wager for a selected wager option. The system can receive from the one or more users, a payment for each wager. The system can price future wager options based on prior wager options. The system can calculate a purchase option metric to determine if the house should opt to purchase unselected wager options. The system can identify a winning wager from actual payout event. The system can allocate some or all of the received payments to one or more of the one or more users in response to the user being associated with the winning wager. Also, the system can allocate the received payments not allocated to the user to the house.”

U.S. Published patent application No. 20070102877 published by Personius teaches “One possible embodiment of the invention could substantially be a system and methodology for a pari-mutuel form of sports square wagering, which may utilize a wager format and a wager processing center. The wagering format, having paper and electronic forms, could be used to communicate wagering information to the wager processing center. The wager format may have a wager entry means, which could be grid having gaming squares through which the gambler could record or otherwise denote the gambler's selection of one or more potential winning occurrence(s). The wager processing center could be an institution generally comprising of the capability of receiving and handing of wagers and a common wager pool into which wagered funds are placed and from which winning wagers are paid.”

However, these solutions still do not solve all of the problems associated with. Thus, it is desirable to solve some of the problems associated with social contests.

### SUMMARY OF THE INVENTION

In accordance with preferred embodiments of the present invention, some of the problems associated with social contents are overcome. A method and system for social contests is presented.

The method and system include an application for social contests that allows new social contests to be created for private and public groups of people. An administrator of a social contest creates a unique new social contest or selects from plural pre-determined social contests. Participants join the social contests with a QR code, a push message or an invite from a social media site. Participants in the social contest invite their friends to participate in the social contest and participants can message each other directly during the social contest. A graphical user interface is presented on the application to allow creation and administration of the social contests.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic social contests processing and display system;

FIG. 2 is a block diagram illustrating an exemplary social contest display system;

FIG. 3 is a block diagram illustrating an exemplary networking protocol stack;

FIG. 4 is a block diagram illustrating an exemplary cloud communications network;

FIG. 5 is a block diagram illustrating an exemplary cloud storage object;

FIG. 6 is a block diagram illustrating wearable network devices;

FIGS. 7A and 7B are a flow diagram illustrating a method for providing social contests;

FIG. 8 is a block diagram illustrating a graphical user interface for providing social contests;

FIG. 9 is a flow diagram illustrating a method for providing social contests;

FIGS. 10A-10E are a flow diagram illustrating a method for providing social contests;

FIG. 11 is a block diagram illustrating exchange of social contest information via a Near Field Communications (NFC) protocol; and

FIG. 12 is a block diagram illustrating exchange of social contest, information via a communications network.

### DETAILED DESCRIPTION OF PREFERRED EMBODIMENTS

### Exemplary Electronic Message Processing and Display System

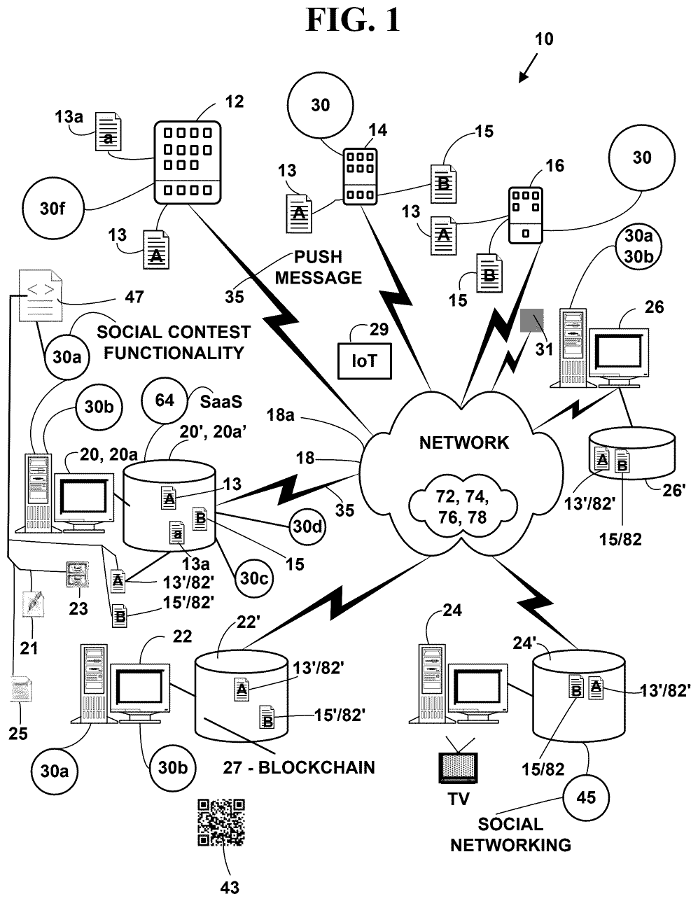

FIG. 1 is a block diagram illustrating an exemplary electronic message display system 10 for sending and receiving electronic messages for social contests. The exemplary electronic system 10 includes, but is not limited to, one or more target network devices 12, 14, 16, etc. each with one or more processors and each with a non-transitory computer readable medium.

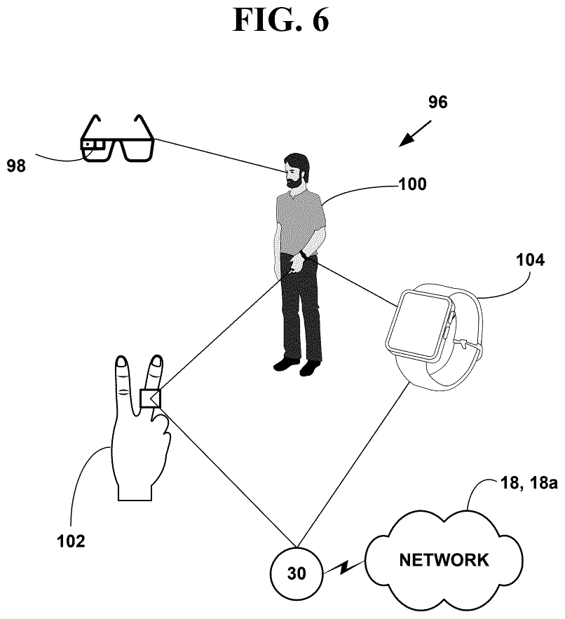

The one or more target network devices 12, 14, 16 (illustrated in FIG. 1 only as a tablet and two smart phones for simplicity) include, but are not limited to, desktop and laptop computers, tablet computers, mobile phones, non-mobile phones with displays, three-dimensional (3D) printers, robots, smart phones, Internet phones, Internet appliances, personal digital/data assistants (PDA), portable, handheld and desktop video game devices, Internet of Things (IoT) devices 29, cable television (CATV), satellite television (SATV) and Internet television set-top boxes, digital televisions including high definition television (HDTV), three-dimensional (3DTV) televisions, wearable network devices 106-112 (FIG. 6), smart speakers 31 and/or other types of network devices.

A “smart phone” is a mobile phone 14 that offers more advanced computing ability and connectivity than a contemporary basic feature phone. Smart phones and feature phones may be thought of as handheld computers integrated with a mobile telephone, but while most feature phones are able to run applications based on platforms such as JAVA ME, a smart phone usually allows the user to install and run more advanced applications. Smart phones and/or tablet computers run complete operating system software providing a platform for application developers.

The tablet computers 12 include, but are not limited to, tablet computers such as the IPAD, by APPLE, Inc., the HP Tablet, by HEWLETT PACKARD, Inc., the PLAYBOOK, by RIM, Inc., the TABLET, by SONY, Inc., etc.

A “smart speaker” 31 is a type of wireless speaker and voice command device with an integrated virtual assistant that offers interactive actions and hands-free activation with the help of one “hot word” (or several “hot words”). Some smart speakers can also act as a smart device that utilizes Wi-Fi, Bluetooth and other wireless protocol standards to extend usage beyond audio playback, such as to control home automation devices. This can include, but is not be limited to, features such as compatibility across a number of services and platforms, peer-to-peer connection through mesh networking, virtual assistants, and others. Each can have its own designated interface and features in-house, usually launched or controlled via application or home automation software. Some smart speakers also include a screen to show the user a visual response.

The IoT network devices 29, include but are not limited to, security cameras, doorbells with real-time video cameras, baby monitors, televisions, set-top boxes, lighting, heating (e.g., smart thermostats, etc.), ventilation, air conditioning (HVAC) systems, and appliances such as washers, dryers, robotic vacuums, air purifiers, ovens, refrigerators, freezers, toys, game platform controllers, game platform attachments (e.g., guns, googles, sports equipment, etc.), and/or other IoT network devices.

The target network devices 12, 14, 16 are in communications with a non-cloud computing network 18 or a cloud communications network 18a or via one or more wired and/or wireless communications interfaces. The cloud communications network 18a, is also called a “cloud computing network” herein and the terms may be used interchangeably.

The plural target network devices 12, 14, 16 make requests 13, 15 for electronic messages (e.g., SMS, MMS, etc.) via the cloud communications network 18 or non-cloud communications network 18a.

The non-cloud communications network 18 and the cloud communications network 18a includes, but is not limited to, communications over a wire connected to the target network devices, wireless communications, and other types of communications using one or more communications and/or networking protocols.

Plural server network devices 20, 22, 24, 26 (only four of which are illustrated) each with one or more processors and a non-transitory computer readable medium include one or more associated databases 20′, 22′, 24′, 26′. The plural network devices 20, 22, 24, 26 are in communications with the one or more target devices 12, 14, 16, 31, 98-104 via the cloud communications network 18a and non-cloud communications network 18.

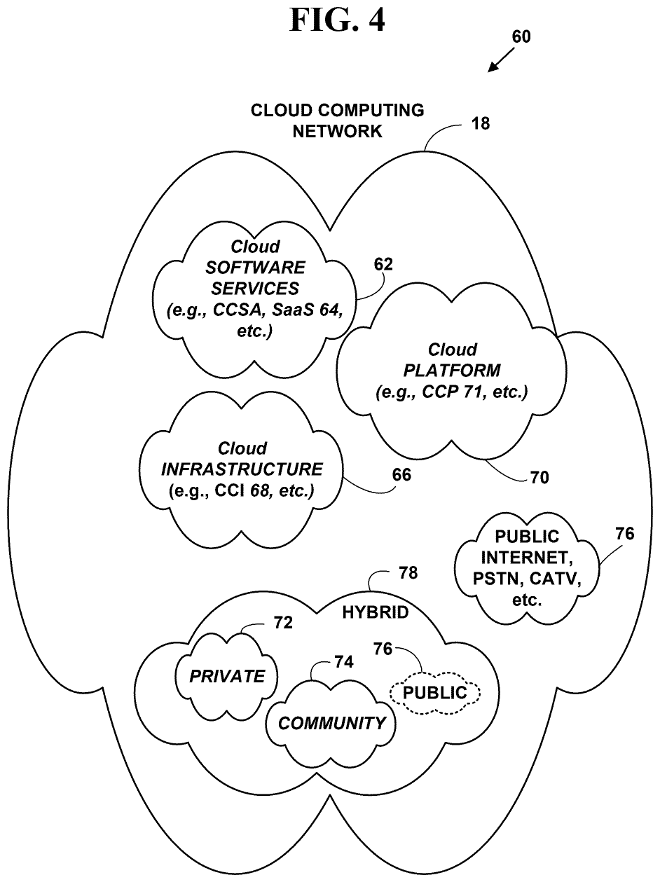

Plural server network devices 20, 22, 24, 26 (only four of which are illustrated) are physically located on one more public networks 76 (See FIG. 4), private networks 72, community networks 74 and/or hybrid networks 78 comprising the cloud network 18.

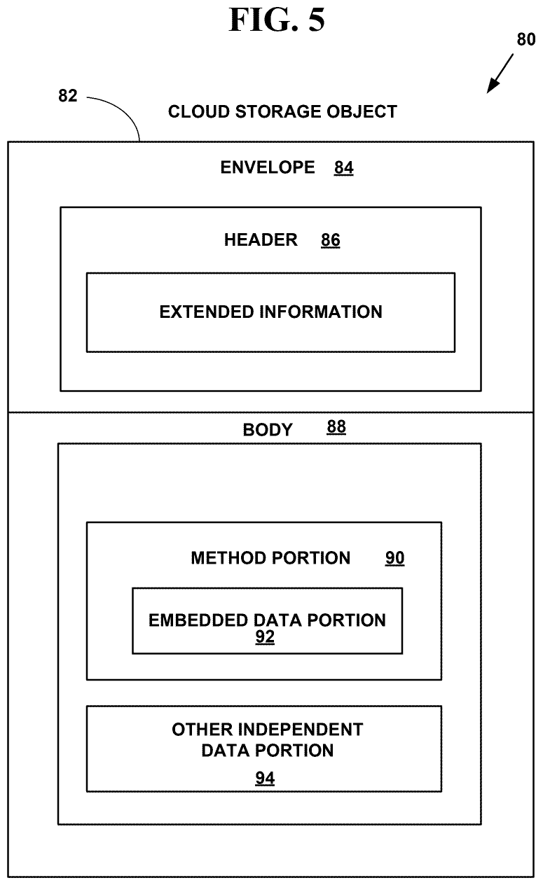

One or more server network devices (e.g., 20, 22, 24, 26, etc.) store portions 13′, 15′ of the electronic content 13, 15 (e.g., SMS, MMS messages, etc.) as cloud storage objects 82 (FIG. 5) as is described herein.

The plural server network devices 20, 22, 24 26, may be connected to, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for cloud computing providers, etc.

The cloud communications network 18a and non-cloud communications network 18 includes, but is not limited to, a wired and/or wireless communications network comprising one or more portions of: the Internet, an intranet, a Local Area Network (LAN), a wireless LAN (WILAN), a Wide Area Network (WAN), a Metropolitan Area Network (MAN), a Public Switched Telephone Network (PSTN), a Wireless Personal Area Network (WPAN) and other types of wired and/or wireless communications networks 18.

The cloud communications network 18a and non-cloud communications network 18 includes one or more gateways, routers, bridges and/or switches. A gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary electronic information display system 10 include a processing system with one or more high speed Central Processing Unit(s) (CPU), processors, one or more memories and/or other types of non-transitory computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The non-transitory computer readable medium includes cooperating or interconnected computer readable medium, which exist exclusively on the processing system or can be distributed among multiple interconnected processing systems that may be local or remote to the processing system.

### Exemplary Electronic Content Display System

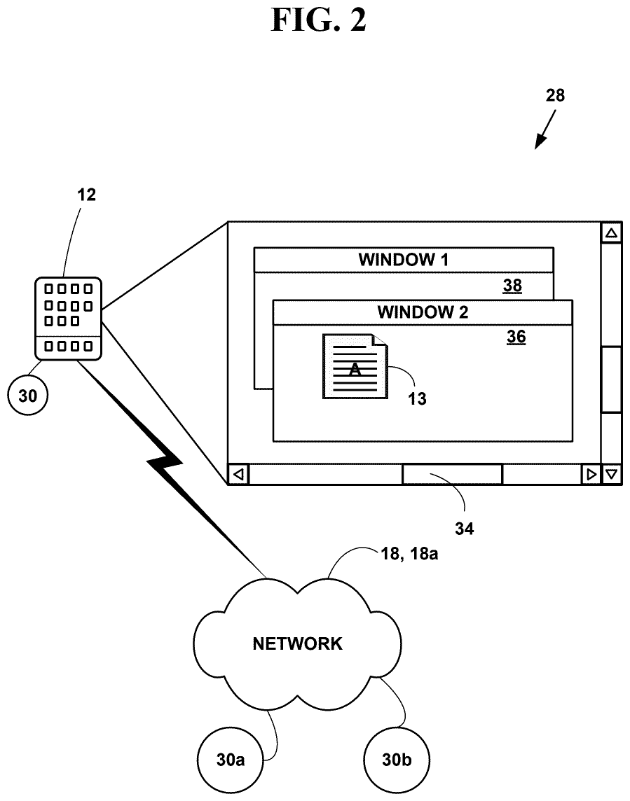

FIG. 2 is a block diagram illustrating an exemplary electronic message information display system 28. The exemplary electronic message information display system 12′ includes, but is not limited to a target network device (e.g., 12, etc.) with an application 30 and a display component 32. The application 30 presents a graphical user interface (GUI) 34 on the display 32 component. The GUI 32 presents a multi-window 36, 38, etc. (only two of which are illustrated) interface to a user.

In one embodiment of the invention, the application 30 is a software application. However, the present invention is not limited to this embodiment and the application 30 can be hardware, firmware, hardware and/or any combination thereof. In one embodiment, the application 30 includes a mobile application for a smart phone, electronic tablet and/or other network device. In one embodiment, the application 30 includes web-browser based application. In one embodiment, the application 30 includes a web-chat client application. In another embodiment, the application 30a, 30b, 30c, 30d, 30e, 30f includes a cloud application used on a cloud communications network 18. However, the present invention is not limited these embodiments and other embodiments can be used to practice the invention

In another embodiment, a portion of the application 30 is executing on the target network devices 12, 14, 16, 31, 98-104 and another portion of the application 30a, 30b, 30c, 30d, 30e, 30f is executing on the server network devices 20, 22, 24, 26. The applications also include one or more library applications. However, the present invention is not limited these embodiments and other embodiments can be used to practice the invention.

### Exemplary Networking Protocol Stack

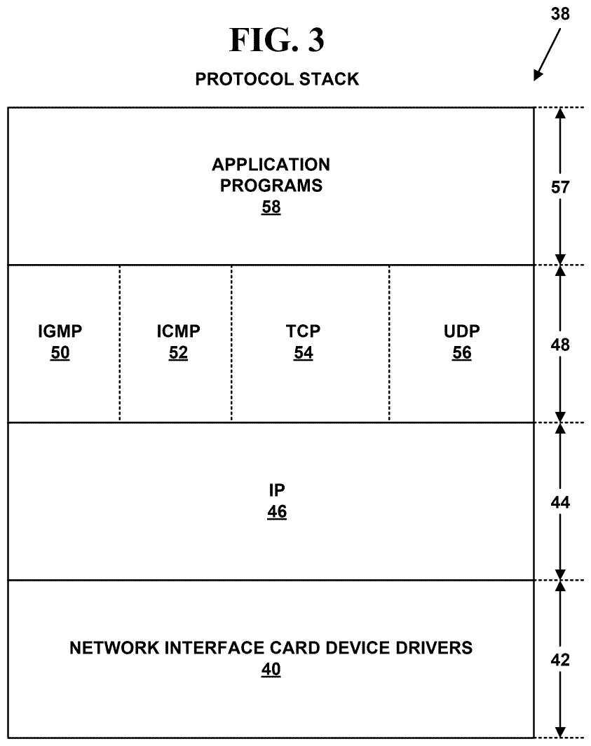

FIG. 3 a block diagram illustrating a layered protocol stack 38 for network devices in the electronic message information display system 10. The layered protocol stack 38 is described with respect to Internet Protocol (IP) suites comprising in general from lowest-to-highest, a link 42, network 44, transport 48 and application 56 layers. However, more or fewer layers could also be used, and different layer designations could also be used for the layers in the protocol stack 38 (e.g., layering based on the Open Systems Interconnection (OSI) model including from lowest-to-highest, a physical, data-link, network, transport, session, presentation and application layer.).

The network devices 12, 14, 16, 20, 22, 24, 26, 31, 98-104 are connected to the communication network 18 with Network Interface Card (NIC) cards including device drivers 40 in a link layer 42 for the actual hardware connecting the network devices 12, 14, 16, 20, 22, 24, 26, 31, 98-104 to the cloud communications network 18. For example, the NIC device drivers 40 may include a serial port device driver, a digital subscriber line (DSL) device driver, an Ethernet device driver, a wireless device driver, a wired device driver, etc. The device drivers interface with the actual hardware being used to connect the network devices to the cloud communications network 18. The NIC cards have a medium access control (MAC) address that is unique to each NIC and unique across the whole cloud network 18. The Medium Access Control (MAC) protocol is used to provide a data link layer of an Ethernet LAN system and for other network systems.

Above the link layer 42 is a network layer 44 (also called the Internet Layer for Internet Protocol (IP) suites). The network layer 44 includes, but is not limited to, an IP layer 46.

IP 46 is an addressing protocol designed to route traffic within a network or between networks. However, more fewer or other protocols can also be used in the network layer 44, and the present invention is not limited to IP 46. For more information on IP 46 see IETF RFC-791, incorporated herein by reference.

Above network layer 44 is a transport layer 48. The transport layer 48 includes, but is not limited to, an optional Internet Group Management Protocol (IGMP) layer 50, a Internet Control Message Protocol (ICMP) layer 52, a Transmission Control Protocol (TCP) layer 52 and a User Datagram Protocol (UDP) layer 54. However, more, fewer or other protocols could also be used in the transport layer 48.

Optional IGMP layer 50, hereinafter IGMP 50, is responsible for multicasting. For more information on IGMP 50 see RFC-1112, incorporated herein by reference. ICMP layer 52, hereinafter ICMP 52 is used for IP 46 control. The main functions of ICMP 52 include error reporting, reachability testing (e.g., pinging, etc.), route-change notification, performance, subnet addressing and other maintenance. For more information on ICMP 52 see RFC-792, incorporated herein by reference. Both IGMP 50 and ICMP 52 are not required in the protocol stack 38. ICMP 52 can be used alone without optional IGMP layer 50.

TCP layer 54, hereinafter TCP 54, provides a connection-oriented, end-to-end reliable protocol designed to fit into a layered hierarchy of protocols which support multi-network applications. TCP 54 provides for reliable inter-process communication between pairs of processes in network devices attached to distinct but interconnected networks. For more information on TCP 54 see RFC-793, incorporated herein by reference.

UDP layer 56, hereinafter UDP 56, provides a connectionless mode of communications with datagrams in an interconnected set of computer networks. UDP 56 provides a transaction oriented datagram protocol, where delivery and duplicate packet protection are not guaranteed. For more information on UDP 56 see RFC-768, incorporated herein by reference. Both TCP 54 and UDP 56 are not required in protocol stack 38. Either TCP 54 or UDP 56 can be used without the other.

Above transport layer 48 is an application layer 57 where application programs 58 (e.g., 30, 30a, 30b, 30c, 30d, etc.) to carry out desired functionality for a network device reside. For example, the application programs 58 for the client network devices 12, 14, 16, 31, 98-104 may include web-browsers or other application programs, application program 30, while application programs for the server network devices 20, 22, 24, 26 may include other application programs (e.g., 30a, 30b, 30c, 30d, etc.).

In one embodiment, application program 30 includes a server Social Contests application 30a, a Social Contests functionality application 30b, an Artificial Intelligence (AI) application 30c and/or other application 30d. However, the present invention is not limited to such an embodiment and more, fewer and/or other applications can be used to practice the invention.

However, the protocol stack 38 is not limited to the protocol layers illustrated and more, fewer or other layers and protocols can also be used in protocol stack 38. In addition, other protocols from the Internet Protocol suites (e.g., Simple Mail Transfer Protocol, (SMTP), Hyper Text Transfer Protocol (HTTP), File Transfer Protocol (FTP), Dynamic Host Configuration Protocol (DHCP), DNS, etc.), Short Message Peer-to-Peer (SMPP), and/or other protocols from other protocol suites may also be used in protocol stack 38.

In addition, markup languages such as HyperText Markup Language (HTML), Extensible Markup Language (XML) and others are used.

HyperText Markup Language (HTML) is a markup language for creating web pages and other information that can be displayed in a web browser.

HTML is written in the form of HTML elements consisting of tags enclosed in angle brackets within the web page content. HTML tags most commonly come in pairs although some tags represent empty elements and so are unpaired. The first tag in a pair is the start tag, and the second tag is the end tag (they are also called opening tags and closing tags). In between these tags web designers can add text, further tags, comments and other types of text-based content.

The purpose of a web browser is to read HTML documents and compose them into visible or audible web pages. The browser does not display the HTML tags, but uses the tags to interpret the content of the page.

HTML elements form the building blocks of all websites. HTML allows images and objects to be embedded and can be used to create interactive forms. It provides a means to create structured documents by denoting structural semantics for text such as headings, paragraphs, lists, links, quotes and other items. It can embed scripts written in languages such as JavaScript which affect the behavior of HTML web pages.

Extensible Markup Language (XML) is another markup language that defines a set of rules for encoding documents in a format that is both human-readable and machine-readable. It is defined in the XML 1.0 Specification produced by the W3C, the contents of which are incorporated by reference and several other related specifications, all free open standards.

XML a textual data format with strong support via Unicode for the languages of the world. Although the design of XML focuses on documents, it is widely used for the representation of arbitrary data structures, for example in web services. The oldest schema language for XML is the Document Type Definition (DTD). DTDs within XML documents define entities, which are arbitrary fragments of text and/or markup tags that the XML processor inserts in the DTD itself and in the XML document wherever they are referenced, like character escapes.

The Short Message Peer-to-Peer (SMPP) protocol in the telecommunications industry is an open, industry standard protocol designed to provide a flexible data communication interface for the transfer of short message data between External Short Messaging Entities, Routing Entities (ESME) and Short Message Service Center (SMSC).

Preferred embodiments of the present invention include network devices and wired and wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum.

### Wireless Interfaces

In one embodiment of the present invention, the wireless interfaces on network devices 12, 14, 16, 20, 22, 24, 26, 31, 98-104 include but are not limited to, IEEE 802.11a, 802.11b, 802.11 g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. However, the present invention is not limited to such an embodiment and other 802.11xx and other types of wireless interfaces can also be used.

802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11AX interfaces can also be used and the present invention is not limited to the 802.11 protocols defined. The IEEE 802.11a, 802.11b and 802.11g standards are incorporated herein by reference.

Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

In one embodiment, the plural server network devices 20, 22, 24, 26 include a connection to plural network interface cards (NICs) in a backplane connected to a communications bus. The NIC cards provide gigabit/second (1×10⁹ bits/second) communications speed of electronic information. This allows “scaling out” for fast electronic content retrieval. The NICs are connected to the plural server network devices 20, 22, 24, 26 and the cloud communications network 18. However, the present invention is not limited to the NICs described and other types of NICs in other configurations and connections with and/or without buses can also be used to practice the invention.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 18 or non-cloud communications network 18.

The one or more target network devices 12, 14, 16, 20, 22, 24, 26, 31, 98-104 and one or more server network devices 20, 22, 24, 26 communicate with each other and other network devices with near field communications (NFC) 185 and/or machine-to-machine (M2M) communications.

Near field communication (NFC) 185 is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags 99 and/or sensor.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

An “RFID tag” is an object that can be applied to or incorporated into a product, animal, or person for the purpose of identification and/or tracking using RF signals.

An “RFID sensor” is a device that measures a physical quantity and converts it into an RF signal which can be read by an observer or by an instrument (e.g., target network devices 12, 14, 16, 20, 22, 24, 26, 31, 98-104, server network devices 20, 22, 24, 26, etc.)

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modern M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

However, the present invention is not limited to such wireless interfaces and wireless networks and more, fewer and/or other wireless interfaces can be used to practice the invention.

### Wired Interfaces

In one embodiment of the present invention, the wired interfaces include wired interfaces and corresponding networking protocols for wired connections to the Public Switched Telephone Network (PSTN) and/or a cable television network (CATV) and/or satellite television networks (SATV) and/or three-dimensional television (3DTV), including HDTV that connect the network devices 12, 14, 16, 20, 22, 24, 26, 31, 98-104 via one or more twisted pairs of copper wires, digital subscriber lines (e.g. DSL, ADSL, VDSL, etc.) coaxial cable, fiber optic cable, other connection media or other connection interfaces. The PSTN is any public switched telephone network provided by AT&T, GTE, Sprint, MCI, SBC, Verizon and others. The CATV is any cable television network provided by the Comcast, Time Warner, etc. However, the present invention is not limited to such wired interfaces and more, fewer and/or other wired interfaces can be used to practice the invention.

### Television Services

In one embodiment, the cloud applications 30, 30a, 30b, 30c, 30d, 30e, 30f provide cloud SaaS 64 services and/or non-cloud application services from television services over the cloud communications network 18a or application services over the non-cloud communications network 18. The television services include digital television services, including, but not limited to, cable television, satellite television, high-definition television, three-dimensional, televisions and other types of network devices.

However, the present invention is not limited to such television services and more, fewer and/or other television services can be used to practice the invention.

### Internet Television Services

In one embodiment, the cloud applications 30, 30a, 30b, 30c, 30d, 30e, 30f provide cloud SaaS 64 services and/or non-cloud application services from Internet television services over the cloud communications network 18a or non-cloud communications network 18. The television services include Internet television, Web-TV, and/or Internet Protocol Television (IPtv) and/or other broadcast television services.

“Internet television” allows users to choose a program or the television show they want to watch from an archive of programs or from a channel directory. The two forms of viewing Internet television are streaming content directly to a media player or simply downloading a program to a viewer's set-top box, game console, computer, or other network device.

“Web-TV” delivers digital content via broadband and mobile networks. The digital content is streamed to a viewer's set-top box, game console, computer, or other network device.

“Internet Protocol television (IPtv)” is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats.

However, the present invention is not limited to such Internet Television services and more, fewer and/or other Internet Television services can be used to practice the invention.

### General Search Engine Services

In one embodiment, the cloud applications 30, 30a, 30b, 30c, 30d, 30e, 30f provide cloud SaaS 64 services and/or non-cloud application services from general search engine services. A search engine is designed to search for information on a cloud communications network 18a or non-cloud communications network 18 such as the Internet including World Wide Web servers, HTTP, FTP servers etc. The search results are generally presented in a list of electronic results. The information may consist of web pages, images, electronic information, multimedia information, and other types of files. Some search engines also mine data available in databases or open directories. Unlike web directories, which are maintained by human editors, search engines typically operate algorithmically and/or are a mixture of algorithmic and human input.

In one embodiment, the cloud applications 30, 30a, 30b, 30c, 30d, 30e, 30f provide cloud SaaS 64 services and/or non-cloud application services from general search engine services. In another embodiment, the cloud applications 30, 30a, 30b, 30c, 30d, 30e, 30f provide general search engine services by interacting with one or more other public search engines (e.g., GOOGLE, BING, YAHOO, etc.) and/or private search engine services.

In another embodiment, the cloud applications 30, 30a, 30b, 30c, 30d, 30e, 30f provide cloud SaaS 64 services and/or non-cloud application services from specialized search engine services, such as vertical search engine services by interacting with one or more other public vertical search engines and/or private search engine services.

However, the present invention is not limited to such general and/or vertical search engine services and more, fewer and/or other general search engine services can be used to practice the invention.

### Social Networking Services

In one embodiment, the cloud applications 30, 30a, 30b, 30c, 30d, 30e, 30f provide cloud SaaS 64 services and/or non-cloud application services from one more social networking services including to/from one or more social networking web-sites (e.g., FACEBOOK, YOUTUBE, TWITTER, INSTAGRAM, etc.). The social networking web-sites also include, but are not limited to, social couponing sites, dating web-sites, blogs, RSS feeds, and other types of information web-sites in which messages can be left or posted for a variety of social activities.

However, the present invention is not limited to the social networking services described and other public and private social networking services can also be used to practice the invention.

### Security and Encryption

Network devices 12, 14, 16, 20, 22, 24, 26, 31, 98-104 with wired and/or wireless interfaces of the present invention include one or more of the security and encryptions techniques discussed herein for secure communications on the cloud communications network 18a or non-cloud communications network 18.

Application programs 58 (FIG. 2) include security and/or encryption application programs integral to and/or separate from the applications 30, 30a, 30b, 30c, 30d. Security and/or encryption programs may also exist in hardware components on the network devices (12, 14, 16, 20, 22, 24, 26, 31, 98-104) described herein and/or exist in a combination of hardware, software and/or firmware.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

RC4 is cipher designed by RSA Data Security, Inc. of Bedford, Massachusetts, which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i standard is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES).

DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired and incorporated herein by reference.

“Hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length<2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

Providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

An Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

The HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

The SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security methods are negotiated between the source and destination at the start of establishing a protocol session. The SSL 2.0 protocol specification, by Kipp E. B. Hickman, 1995 is incorporated herein by reference. More information on SSL is available at the domain name See “netscape.com/eng/security/SSL_2.html.”

Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, California is supplier of networking hardware and software, including router and security products.

However, the present invention is not limited to such security and encryption methods described herein and more, fewer and/or other types of security and encryption methods can be used to practice the invention. The security and encryption methods described herein can also be used in various combinations and/or in different layers of the protocol stack 38 with each other.

### Cloud Computing Networks

FIG. 4 is a block diagram 60 illustrating an exemplary cloud computing network 18. The cloud computing network 18 is also referred to as a “cloud communications network” 18. However, the present invention is not limited to this cloud computing model and other cloud computing models can also be used to practice the invention. The exemplary cloud communications network includes both wired and/or wireless components of public and private networks.

In one embodiment, the cloud computing network 18 includes a cloud communications network 18 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Exemplary cloud computing essential characteristics appear in Table 1. However, the present invention is not limited to these essential characteristics and more, fewer or other characteristics can also be used to practice the invention.

TABLE 1
1. On-demand Social Gamin services. Automatic Social Contests service
scan unilaterally provision computing capabilities, such as server time
and network storage, as needed automatically without requiring
human interaction with each network server on the cloud
communications network 18.
2. Broadband network access. Automatic Social Contests services
capabilities are available over plural broadband communications
networks and accessed through standard mechanisms that promote
use by heterogeneous thin or thick client platforms (e.g., mobile
phones, smart phones 14, tablet computers 12, laptops, PDAs, etc.).
The broadband network access includes high speed network access
such as 4G and 5G wireless and/or wired and broadband and/or ultra-
broad band (e.g., WiMAX, etc.) network access.
3. Resource pooling. Automatic Social Contests services resources are
pooled to serve multiple requesters using a multi-tenant model, with
different physical and virtual resources dynamically assigned and
reassigned according to demand. There is location independence in
that a requester of services has no control and/or knowledge over the
exact location of the provided by the Social Contests service resources
but may be able to specify location at a higher level of abstraction
(e.g., country, state, or data center). Examples of pooled resources
include storage, processing, memory, network bandwidth, virtual
server network device and virtual target network devices.
4. Rapid elasticity. Capabilities can be rapidly and elastically provisioned,
in some cases automatically, to quickly scale out and rapidly released
to quickly scale for Social Contests services collaboration. For
automatic Social Contests services, multi-media collaboration
converters, the automatic Social Contests services collaboration and
analytic conversion capabilities available for provisioning appear to be
unlimited and can be used in any quantity at any time.
5. Measured Services. Cloud computing systems automatically control and
optimize resource use by leveraging a metering capability at some
level of abstraction appropriate to the type of automatic Social
Contests services (e.g., storage, processing, bandwidth, custom
electronic content retrieval applications, etc.). Electronic Automatic
Social Contests services collaboration conversion usage is monitored,
controlled, and reported providing transparency for both the
automatic Social Contests services provider and the automatic Social
Contests service requester of the utilized electronic content storage
retrieval service.

Exemplary cloud computing service models illustrated in FIG. 4 appear in Table 2. However, the present invention is not limited to these service models and more, fewer or other service models can also be used to practice the invention.

TABLE 2
1. Cloud Computing Software Applications 62 for Social Contests
services (CCSA, SaaS 64). The capability to use the provider's
applications 30, 30a, 30b, 30c, 30d, 30e, 30f running on a cloud
infrastructure 66. The cloud computing applications 62, are accessible
from the server network device 20 from various client devices 12, 14,
16 through a thin client interface such as a web browser, etc. The
user does not manage or control the underlying cloud infrastructure
66 including network, servers, operating systems, storage, or even
individual application 30, 30a, 30b, 30c, 30d, 30e, 30f capabilities,
with the possible exception of limited user-specific application
configuration settings.
2. Cloud Computing Infrastructure 66 for Social Contests services
(CCI 68). The capability provided to the user is to provision
processing, storage and retrieval, networks 18, 72, 74, 76, 78 and
other fundamental computing resources where the consumer is able to
deploy and run arbitrary software, which can include operating
systems and applications 30, 30a, 30b, 30c, 30d. The user does not
manage or control the underlying cloud infrastructure 66 but has
control over operating systems, storage, deployed applications, and
possibly limited control of select networking components (e.g., host
firewalls, etc.).
3. Cloud Computing Platform 70 for Social Contests services (CCP 71).
The capability provided to the user to deploy onto the cloud
infrastructure 66 created or acquired applications created using
programming languages and tools supported servers 20, 22, 24, 26,
etc.. The user not manage or control the underlying cloud
infrastructure 66 including network, servers, operating systems, or
storage, but has control over the deployed applications 30a, 30b, 30c,
30d, 30e, 30f and possibly application hosting environment
configurations.

Exemplary cloud computing deployment models appear in Table 3. However, the present invention is not limited to these deployment models and more, fewer or other deployment models can also be used to practice the invention.

TABLE 3
1. Private cloud network 72. The cloud network infrastructure is operated
solely for Social Contests services. It may be managed by the
electronic content retrieval or a third party and may exist on premise
or off premise.
2. Community cloud network 74. The cloud network infrastructure is
shared by several different organizations and supports a specific
electronic content storage and retrieval community that has shared
concerns (e.g., mission, security requirements, policy, compliance
considerations, etc.). It may be managed by the different organizations
or a third party and may exist on premise or off premise.
3. Public cloud network 76. The cloud network infrastructure such as the
Internet, PSTN, SATV, CATV, Internet TV, etc. is made available to
the general public or a large industry group and is owned by one or
more organizations selling cloud services.
4. Hybrid cloud network 78. The cloud network infrastructure 66 is a
composition of two and/or more cloud networks 18 (e.g., private 72,
community 74, and/or public 76, etc.) and/or other types of public
and/or private networks (e.g., intranets, etc.) that remain unique
entities but are bound together by standardized or proprietary
technology that enables data and application portability (e.g., cloud
bursting for load-balancing between clouds, etc.)

Cloud software 64 for electronic content retrieval takes full advantage of the cloud paradigm by being service oriented with a focus on statelessness, low coupling, modularity, and semantic interoperability for electronic content retrieval. However, cloud software services 64 can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the cloud application 30, 30a, 30b, 30c, 30d, offers cloud services for Social Contests. The application 30, 30a, 30b, 30c, 30d, 30e, 30f offers the cloud computing Infrastructure 66, 68 as a Service 62 (IaaS), including a cloud software infrastructure service 62, the cloud Platform 70, 71 as a Service 62 (PaaS) including a cloud software platform service 62 and/or offers Specific cloud software services as a Service 64 (SaaS) including a specific cloud software service 64 for Social Contests services. The IaaS, PaaS and SaaS include one or more of cloud services 62 comprising networking, storage, server network device, virtualization, operating system, middleware, run-time, data and/or application services, or plural combinations thereof, on the cloud communications network 18.

FIG. 5 is a block diagram 80 illustrating an exemplary cloud storage object 82. One or more server network devices (e.g., 20, 22, 24, 26, etc.) store portions 13′, 15′ of the electronic message content 13, 15 (e.g., SMS, MMS, etc.) as cloud storage objects 82 (FIG. 5) as is described herein.

The cloud storage object 82 includes an envelope portion 84, with a header portion 86, and a body portion 88. However, the present invention is not limited to such a cloud storage object 82 and other cloud storage objects and other cloud storage objects with more, fewer or other portions can also be used to practice the invention.

The envelope portion 84 uses unique namespace Uniform Resource Identifiers (URIs) and/or Uniform Resource Names (URNs), and/or Uniform Resource Locators (URLs) unique across the cloud communications network 18 to uniquely specify, location and version information and encoding rules used by the cloud storage object 82 across the whole cloud communications network 18. For more information, see IETF RFC-3305, Uniform Resource Identifiers (URIs), URLs, and Uniform Resource Names (URNs), the contents of which are incorporated by reference.

The envelope portion 84 of the cloud storage object 82 is followed by a header portion 86. The header portion 86 includes extended information about the cloud storage objects such as authorization and/or transaction information, etc.

The body portion 88 includes methods 90 (i.e., a sequence of instructions, etc.) for using embedded application-specific data in data elements 92. The body portion 88 typically includes only one portion of plural portions of application-specific data 92 and independent data 94 so the cloud storage object 82 can provide distributed, redundant fault tolerant, security and privacy features described herein.

Cloud storage objects 82 have proven experimentally to be a highly scalable, available and reliable layer of abstraction that also minimizes the limitations of common file systems. Cloud storage objects 82 also provide low latency and low storage and transmission costs.

Cloud storage objects 82 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 18. Cloud storage objects 82 are also highly durable because of creation of copies of portions of desired electronic content across such networks 72, 74, 76, 78 of the cloud communications network 18a. Cloud storage objects 82 includes one or more portions of desired electronic content and can be stored on any of the 72, 74, 76, 78 networks of the cloud communications network 18. Cloud storage objects 82 are transparent to a requester of desired electronic content and are managed by cloud applications 30, 30a, 30b, 30c, 30d.

In one embodiment, cloud storage objects 82 are configurable arbitrary objects with a size up to hundreds of terabytes, each accompanied by with a few kilobytes of metadata. Cloud objects are organized into and identified by a unique identifier unique across the whole cloud communications network 18. However, the present invention is not limited to the cloud storage objects described, and more fewer and other types of cloud storage objects can be used to practice the invention.

Cloud storage objects 82 present a single unified namespace or object-space and manages desired electronic content by user or administrator-defined policies storage and retrieval policies. Cloud storage objects includes Representational state transfer (REST), Simple Object Access Protocol (SOAP), Lightweight Directory Access Protocol (LDAP) and/or Application Programming Interface (API) objects and/or other types of cloud storage objects. However, the present invention is not limited to the cloud storage objects described, and more fewer and other types of cloud storage objects can be used to practice the invention.

REST is a protocol specification that characterizes and constrains macro-interactions storage objects of the four components of a cloud communications network 18, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.)

LDAP is a software protocol for enabling storage and retrieval of electronic content and other resources such as files and devices on the cloud communications network 18. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction and provides access to automatic Social Contests services in a cloud or non-cloud environment. In one embodiment, the API for Social Contests services is available to network devices 12, 14, 16, 20, 22, 24, 26, 31, 98-104 and networks 18, 18a. However, the present invention is not limited to such an embodiment and other embodiments can be used to practice the invention.

### Wearable Devices

Wearable technology” and/or “wearable devices” are clothing and accessories incorporating computer and advanced electronic technologies. Wearable network devices provide several advantages including, but not limited to: (1) Quicker access to notifications. Important and/or summary notifications are sent to alert a user to view the whole message. (2) Heads-up information. Digital eye wear allows users to display relevant information like directions without having to constantly glance down; (3) Always-on Searches. Wearable devices provide always-on, hands-free searches; and (4) Recorded data and feedback. Wearable devices take telemetric data recordings and providing useful feedback for users for exercise, health, fitness, etc. activities.

FIG. 6 is a block diagram with 96 illustrating wearable devices. The wearable devices include one or more processors and include, but are not limited to, wearable digital glasses 98, clothing 100, jewelry 102 (e.g., smart rings, smart earrings, etc.) and/or watches 104. However, the present invention is not limited to such embodiments and more, fewer and other types of wearable devices can also be used to practice the invention.

In one specific embodiment, the application 30, 30a, 30b, 30c, 30d, 30e, 30f interacts with wearable devices 98-104 automatic Social Contests services the methods described herein. However, the present invention is not limited this embodiment and other embodiments can also be used to practice the invention.

### Artificial Intelligence (AI) and Big Data

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points.

In one embodiment, the present invention uses one or more AI methods including, but are not limited to, AI knowledge-based methods 30c for (1) Social Contests services as included in Methods 106, 145 and 152 and for playing and predicting and anticipating outcomes in squares pools social gaming contest 128 and/or a money line pick'em 144 social contests. However, the present invention is not limited to such an embodiment and more, fewer and/or other AI methods can be used to practice the invention.

In one embodiment, SaaS 64 includes and AI application 30c with the AI methods described herein. In another embodiment, the AI application 30c is a standalone application. However, the present invention is not limited to such an embodiment, and the AI application 30c can be provided in other than the SaaS 64.

“Big Data” refers to the use of predictive analytic methods that extract value from data, and to a particular size of data set. The quantities of data used are very large, at least 100,000 data points and more typically 500,000 to 1 Million+ data points. Analysis of Big Data sets are used to find new correlations and to spot trends. In one embodiment, SaaS 64 includes and Big Data application 30d with the Big Data described herein.

In one embodiment, the AI methods described herein collect data information to create and store (e.g., in cloud storage object 82, etc.) a Big Data that is used to analyze trends find new correlations and to spot trends. However, the present invention is not limited to such an embodiment and the AI methods described herein can be used without Big Data sets.

### Short Message Service (SMS) Messaging

Short Message Service (SMS) is an electronic text messaging service component of phone, Web, or mobile communication systems. It uses standardized communications protocols to allow fixed line or mobile phone devices to exchange short text messages.

SMS messages were defined in 1985 as part of the Global System for Mobile Communications (GSM) series of standards as a means of sending messages of up to 160 characters to and from GSM mobile handsets. Though most SMS messages are mobile-to-mobile text messages, support for the service has expanded to include other mobile technologies as well as satellite and landline networks.

The SMS Internet Engineering Task Force (IETF) Request for Comments (RFC) 5724, ISSN: 2070-1721, 2010, is incorporated herein by reference.

### Direct and Instant Messages

A “direct message” (DM) is a private form of communication between social media users that is only visible to the sender and recipient(s). INSTAGRAM, TWITTER, FACEBOOK and other platforms, allow for direct messages between their users, with varying restrictions by platform.

An “instant message” (IM) is a type of online chat allowing real-time text transmission over the Internet or another computer network. Messages are typically transmitted between two or more parties, when each user inputs text and triggers a transmission to the recipient, who are all connected on a common network.

### Social Contests

Social contests are contests that involve a group of people who desire to engage in a competitive contest in a pre-determined group. A pre-determined group of people who work in a same office desire to engage in competitive contest based on public events, private events (e.g., occurring only within the pre-determined group) or a combination thereof. Such social contests are engaged in directly (e.g., with an application) on a target network device (e.g. a mobile phone, electronic tablet, wearable device, etc.), via social media (e.g., FACEBOOK, INSTAGRAM, TWITTER, etc.) and/or via other interfaces.

For example, social contests include selecting a contests for picking an intermittent score (e.g., per quarter, inning, half, etc.) or final score of a sporting event (e.g., a football pool, etc.) picking answers to questions created for entertainment, sports, politics, weather or cultural events, picking a winner of a political election, or picking a date, time, date and time or an amount of an occurrence of a public event or private event (e.g., how many runs scored in an inning, how many inches of rain or snow will fall, who will win an entertainment award, etc.) or a combination thereof.

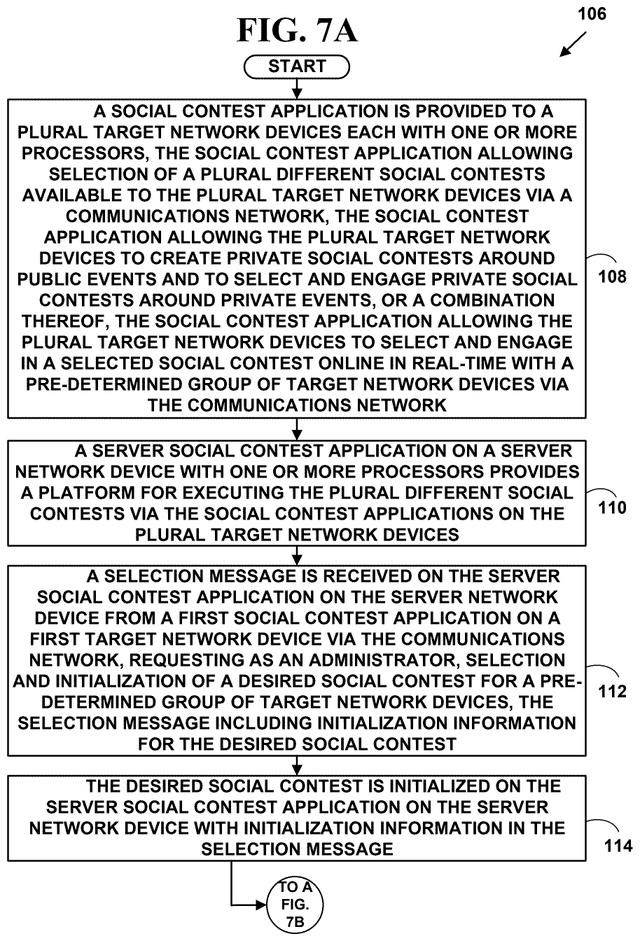

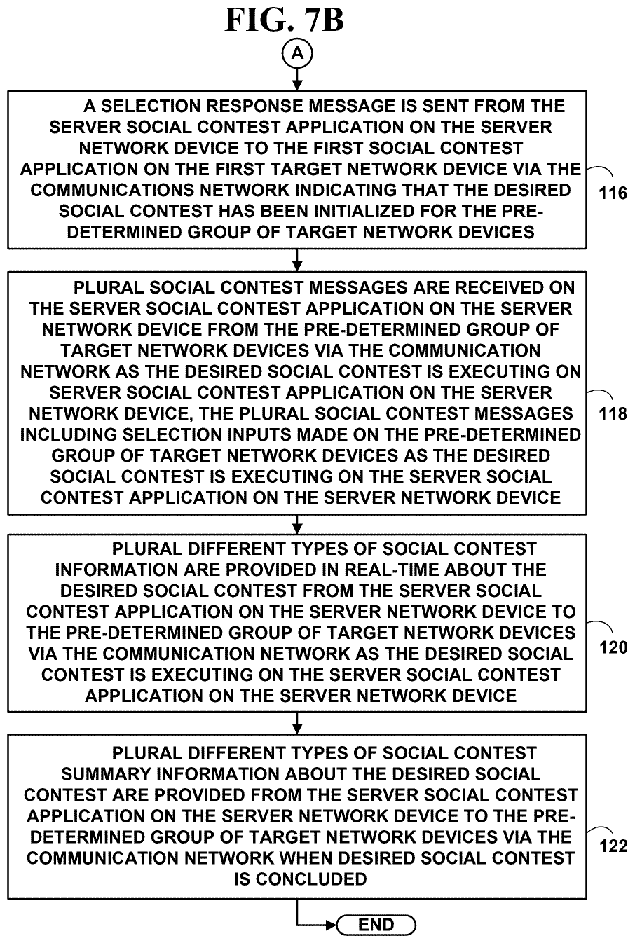

FIGS. 7A and 7B are a flow diagram illustrating a Method 106 for providing social contests.

In FIG. 7A at Step 108, a social contest application is provided to a plural target network devices each with one or more processors, the social contest application allowing selection of a plural different social contests available to the plural target network devices via a communications network, the social contest application allowing the plural target network devices to create private social contests around public events and to select and engage private social contests around private events, or a combination thereof, the social contest application allowing the plural target network devices to select and engage in a selected social contest online in real-time with a pre-determined group of target network devices via the communications network. At Step 110, a server social contest application on a server network device with one or more processors provides a platform for executing the plural different social contests via the social contest applications on the plural target network devices. At Step 112, a selection message is received on the server social contest application on the server network device from a first social contest application on a first target network device via the communications network, requesting as an administrator, selection and initialization of a desired social contest for a pre-determined group of target network devices. The selection message including initialization information for the desired social contest. At Step 114, the desired social contest is initialized on the server social contest application on the server network device with initialization information in the selection message. In FIG. 7B at Step 116, a selection response message is sent from the server social contest application on the server network device to the first social contest application on the first target network device via the communications network indicating that the desired social contest has been initialized for the pre-determined group of target network devices. At Step 118, plural social contest messages are received on the server social contest application on the server network device from the pre-determined group of target network devices via the communication network as the desired social contest is executing on server social contest application on the server network device, the plural social contest messages including selection inputs made on the pre-determined group of target network devices as the desired social contest is executing on the server social contest application on the server network device. At Step 120, plural different types of social contest information are provided in real-time about the desired social contest from the server social contest application on the server network device to the pre-determined group of target network devices via the communication network as the desired social contest is executing on the server social contest application on the server network device. At Step 122, plural different types of social contest summary information about the desired social contest are provided from the server social contest application on the server network device to the pre-determined group of target network devices via the communication network when desired social contest is concluded.

The present invention is illustrated with an exemplary embodiment. However, the present invention is not limited to such an embodiment and other embodiments can be used to practice the invention.

In such an exemplary embodiment in FIG. 7A at Step 108, a social contest application 30 is provided to a plural target network devices 12, 14, 16, 29, 31, 98-104 each with one or more processors. The social contest application 30 allowing selection of a plural different social contests 13, 15 (only two of which are illustrated for simplicity) available to the plural target network devices 12, 14, 16, 29, 31, 98-104 via a communications network 18. The social contest application 30 allowing the plural target network devices 12, 14, 16, 31, 98-104 to select and engage in private social contests around public events 13 and create private social contests around private events 15, or a combination thereof. The social contest application 30 allowing the plural target network devices 12, 14, 16, 29, 31, 98-104 to select and engage in a selected social contest (e.g., 13, etc.) online in real-time (e.g. within a few seconds, etc.) with a pre-determined group of target network devices 12, 14, 16, 29, 31, 98-104 via the communications network 18.

In one embodiment, the private social contests around public events 13 include private social contests around community events, current events, entertainment events, news events, political events, sporting events, weather events, or a combination thereof. However, the present invention is not limited to such embodiments and other embodiments can be used to practice the invention.

In one embodiment, the private social contests around private events 15 includes but is not limited to, professional events or personal events, or a combination thereof, for employees of a company. However, the present invention is not limited to such embodiments and other embodiments can be used to practice the invention.

In one embodiment, the plural different social contests available 13,15 on the social contest application 30 includes, but is not limited to, a plural social gaming contests around public event and/or private events, and/or a combination thereof. However, the present invention is not limited to such embodiments and other embodiments can be used to practice the invention.

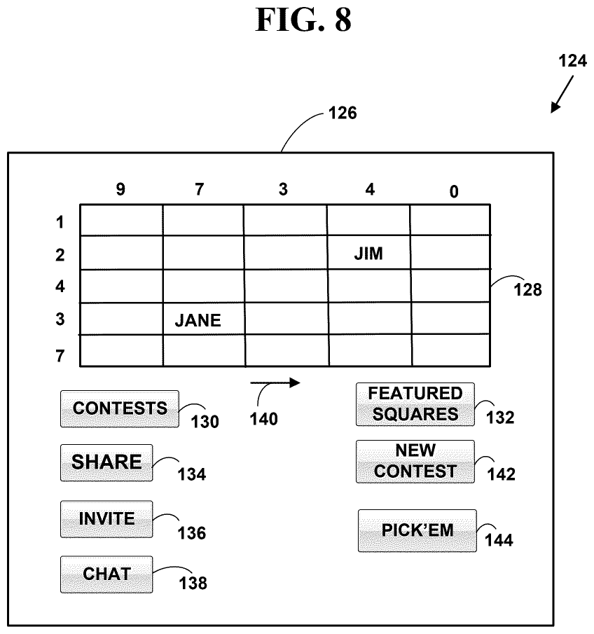

FIG. 8 is a block diagram 124 illustrating a graphical user interface 126 for providing social contests 13, 15.

In one embodiment, the graphical user interface 126 includes a graphical button 130 for selecting a social contest 13, 15, including social gaming contests 25 from the plural available social contests.

The plural social gaming contests 25 available on the social contest application 30 includes, but is not limited to, a squares pools social gaming contest 128 and/or a money line pick'em 144. However, the present invention is not limited to such embodiments and other embodiments can be used to practice the invention.

In one embodiment, the Squares Pools 128 social gaming contests 25 include, but are not limited to, squares pools, block pools and/or box pools. For example, for football games a poster board is created for a football game that has squares or blocks including numbers for scores of each team at the end of each quarter (e.g., 3, 7, 10, 21, etc.) and/or the final score, etc. The Squares Pools 128 social gaming contests 25 can be used other sports such as basketball, hockey, soccer, etc. that have quarters and/or periods and for sports such as baseball and/or softball that have innings, etc. In another embodiment, the Squares Pools 128 gaming contests 25 are defined by the Administrator for any events other than sporting events that include plural discrete events that can be included in a grid of squares. An administrator of the pool has spreadsheets and has a list and/or email list of participants and includes manual processes. Squares Pools 128 social gaming contests 25 is automated and includes plural different square/pool grids including 5×5 pool grids (25 squares illustrated in FIG. 8), 7×7 pool grids (49 squares), 10×10 (100 squares) grids and/or other size pool grids on a graphical layout. Administrators of a Squares and/or Pools social gaming contests 25 can request target network devices 12, 14, 16, 29, 31, 98-104 select one up to ten squares each on the graphical layout of a grid. A winning square is highlighted in real-time live on the graphical layout of the grid based on a current game score and as the score of the football game changes a winning square is displayed somewhere in the graphical layout of the grid around until a quarter goes final. When the football game is over a winner is declared on the graphical layout of the grid and in a summary screen. A winner is awarded every quarter. When a target network device 12, 14, 16, 29, 31, 98-104 selects a square the graphical layout of the grid and displays other target network device 12, 14, 16, 29, 31, 98-104 reserving squares in real-time and available squares disappear when they are selected by a target network device 12, 14, 16, 29, 31, 98-104. However, the present invention is not limited to such embodiments and other embodiments can be used to practice the invention.

In one embodiment, the Squares Pools 128 social gaming contests 25 are active even if all the squares are not reserved. In another embodiment, the Squares Pools 128 social gaming contests 25 will not begin and become active unless all the squares are reserved. However, the present invention is not limited to such an embodiment and other embodiments can be used to practice the invention.

In one embodiment, the user does not know how reserved squares will be applied in the Squares Pools 128 social gaming contests 25. For example, if a user reserve a square in one instance of the contest 25, that square will be applied at the end of a quarter. In another instance of the contest 25, that square will be applied only at the end of a game based on a final score. In another instance of the contest 25, that square will applied to both a score at an end of one or more quarters and/or at the end of the game based on the final score, and/or combinations thereof.

In one embodiment, the Money Line Pick'Em social gaming contest 144 includes, but is not limited to, transforming money line odds to points and the user chooses the winners of each social contest game over some number of matchups. Most total points wins the pool. Favorites are all currently 1000 points, underdogs are worth more and that number varies based on the money line. This social contest game provides live projected standings. The live projected standings are based on games that have gone final and points earned from correct picks plus any points associated with picks a target network device is currently projected to win based on the current score of games in progress that aren't final. However, the present invention is not limited to such embodiments and other embodiments can be used to practice the invention.

In one embodiment, Money Line Pick'Em social gaming contest 144 includes, but is not limited to, is a specific variety of social contest which includes of some various number of actual non-professional and/or professional games (e.g., called “matchups”) such as X-number of professional football, games on a Sunday social contest. The non-professional and/or professional games include, but are not limited to, baseball, basketball, hockey, lacrosse, soccer, softball, etc. There are money lines for each of those games (matchups) that are transformed. The user is attempting to pick the football teams they think will win each of the games. The Monely Line Pick'Em social gaming contest 144 includes a leaderboard that shows how each participant picks are performing.

In one embodiment, the Money Line Pick'Em social gaming contest 144 includes, but is not limited to, a bonus pick. For the bonus pick a user picks one team that you think will score the most points in their matchup out of all the teams that the social contest includes and whatever a total number of points a user's bonus pick team scores that number is added to a final contest score in the standings.

For example, if there are two matchups on this “slate” football team A vs. football team B, and football team C vs. football team D. A user thinks football team B and football team C will win their matchups. The user is then prompted to make a bonus pick. The user picks team C as the bonus pick. It does not matter if team C wins or loses their matchup. What is included in the bonus pick is a number of points a team wins by. If team C wins by 25 points in their matchup vs team D, then 25 points is added to a final score in the overall standings for that contest as a result of the bonus pick. The bonus pick serves as a great tie breaker. The bonus pick allows more variance of scores across the leaderboard and/or standings and reduces the possibility of ties.

In one embodiment, the plural social contests 13, 15 include but are not limited to, selecting a social contest game 25 for picking an intermittent score or final score of a sporting event, picking answers to questions created for entertainment, sports, politics, pop culture, weather and/or cultural events, picking a winner of a political election, or picking a date, time, date and time or an amount of an occurrence of a public event or private event, and/or a combination thereof. However, the present invention is not limited to such embodiments and other embodiments can be used to practice the invention.

Returning to FIG. 7A at Step 110, a server social contest application 30a on a server network device 20, 22, 24, 26 with one or more processors provides a platform for executing the plural different social contests 13, 15 via the social contest applications 30 on the plural target network devices 12, 14, 16, 29, 31, 98-104.

At Step 112, a selection message is received on the server social contest application 30a on the server network device (e.g., 20, etc.) from a first social contest application 30 on a first target network device 12 via the communications network 18 requesting as an administrator, selection and initialization of a desired social contest 13 for a pre-determined group of target network devices (e.g., 12, 14, 16, 29, 31, etc.) The selection message including initialization information for the desired social contest 13.

At Step 114, the desired social contest 13 is initialized on the server social contest application 30a on the server network device 20 with initialization information in the selection message.

In FIG. 7B at Step 116, a selection response message is sent from the server social contest application 30a on the server network device 20 to the first social contest application 30 on the first target network device 12 via the communications network 18 indicating that the desired social contest 13 has been initialized for the pre-determined group of target network devices 12, 14, 16, 29, 31.

At Step 118, plural social contest messages are received on the server social contest application 30a on the server network device 20 from the pre-determined group of target network devices 12, 14, 16, 29, 31 via the communication network 18 as the desired social contest 13 is executing on server social contest application 30a on the server network device 20. The plural social contest messages including selection inputs made on the pre-determined group of target network devices 12, 14, 16, 29, 31 as the desired social contest 13 is executing on the server social contest application 30a on the server network device 20.

At Step 120, plural different types of social contest information 21 are provided in real-time about the desired social contest 13 from the server social contest application 30a on the server network device 20 to the pre-determined group of target network devices 12, 14, 16, 29, 31 via the communication network 18 as the desired social contest 13 is executing on the server social contest application 30a on the server network device 20.

In one embodiment, Step 120 includes, but is not limited to, providing electronic social contest rules, social contest summaries, a social contest leaderboard or a summary of points earned for one or more social contests played and providing electronic information for current, upcoming and previously played social contests 13, 15. However, the present invention is not limited to such embodiments and other embodiments can be used to practice the invention.

In one specific embodiment, the points earned include, but are limited to, points that are useable outside of the social contest application 30 with other applications to obtain goods or services (e.g., airline miles, cash back, discounts on food, lodging, gasoline, car rentals, etc.) provided through the other applications. However, the present invention is not limited to such embodiments and other embodiments can be used to practice the invention.

At Step 122, plural different types of social contest summary information 21 about the desired social contest 13 are provided from the server social contest application 30a on the server network device 20 to the pre-determined group of target network devices 12, 14, 16, 29, 31 via the communication network 18 when desired social contest 13 is concluded. However, the present invention is not limited to such embodiments and other embodiments can be used to practice the invention.

Returning to FIG. 8, in one embodiment, the social contest application 30 includes one or more graphical buttons 132 representing one or more featured social contests 13 from the plural different social contests 13, 15 including a pools social gaming contest 25 available to the plural target network devices 12, 14, 16, 29, 31, 98-104. FIG. 8 illustrates a feature social contest with the graphical button 132 configured for the squares social gaming contest 25. However, the present invention is not limited to such embodiments and other embodiments can be used to practice the invention.

In one embodiment, the social contest application 30 includes, but is not limited to, plural pre-determined templates for pre-determined game “slates” including plural pre-determined games scheduled to be played on a pre-determined date and/or a pre-determined time. In such an embodiment, the social contest application 30 includes a set of basic pre-determined game “slates” where users can choose from when creating a “Money Line Pick'Em” social gaming contest 144 and/or Squares Pools 128 social gaming contest. The pre-determined slates include plural matches and are parsed using pre-determined parameters. For example a Sunday 4 pm ET professional football slate includes every game that starts at 4 pm ET or later on Sunday and also includes the Monday night football game. In another embodiment, the pre-determined slate does not include the Monday night football game. The pre-determined slates include, but are not limited to, professional and/or non-professional games include, but are not limited to, baseball, basketball, hockey, lacrosse, soccer, softball, etc. However, the present invention is not limited to such embodiments and other embodiments can be used to practice the invention.

In one embodiment, the one or more graphical buttons include but are not limited to a graphical SHARE button 134 and a graphical INVITE button 136. However, the present invention is not limited to such embodiments and other embodiments can be used to practice the invention.

In one embodiment, the graphical SHARE button 134 allows a first target network device (e.g. 12, etc.) as an administrator to share the desired social contest 13 that has been selected on the first target network device 12 and initialized via the server social contest application 30a on the server network device 20 via the communications network 18 within the pre-determined group of target network devices 12, 14, 16, 29, 31, or other target network devices 98-104 outside of the pre-determined group of target network devices 12, 14, 16, 29, 31. The SHARE button 134 is active only after the desired social contest 13 has been selected and initialized on the server social contest application 30a on the server network device 20, illustrated by the larger type in FIG. 8. However, the present invention is not limited to such embodiments and other embodiments can be used to practice the invention.

In one embodiment, the graphical INVITE button 136 allows first target network device and the desired group of network devices to invite other target network devices within the pre-determined group of target network devices 12, 14, 16, 29, 31, or other target network devices 98-104 outside of the pre-determined group of target network devices, to participate in the desired social contest 13. The graphical INVITE 136 button is active only after the desired social contest 13 has been selected and initialized server social contest application 30a on the server network device 20. However, the present invention is not limited to such embodiments and other embodiments can be used to practice the invention.

In one embodiment, initiating a selection of the graphical SHARE button 134 or the graphical INVITE button 136 on the first target network device 12 as an administrator includes, sending an email, SMS message, social media message, wireless message or automated voice mail message from the first target network device 12 to the pre-determined group of target network devices 14, 16, 29, 31 and/or other target network devices 98-104 outside of the pre-determined group of target network devices 14, 16, 29, 31. However, the present invention is not limited to such embodiments and other embodiments can be used to practice the invention.

In one embodiment, initiating a selection of the graphical SHARE button 134 or the graphical INVITE button 136 on a selected one (e.g. 14, etc.) of the desired group of network devices 12, 14, 16, 29, 31 includes, sending an email, SMS message, social media message, wireless message or automated voice mail message from the selected one 14 of the desired group of network devices to the first target network device 12, other ones in the pre-determined group of target network devices 14, 16, 29, 31 and/or other target network devices outside of the pre-determined group of target network devices 98-104. However, the present invention is not limited to such embodiments and other embodiments can be used to practice the invention.

In one embodiment, the social contest application 30 includes a real-time chat 138 component allowing the first target network device 12, the pre-determined group of target network devices 14, 16, 29, 31 and/or other target network devices 98-104 outside of the pre-determined group of target network devices 12, 14, 16, 29, 31, to communicate in real-time via the communications network 18 when desired social contest 13 is active. However, the present invention is not limited to such embodiments and other embodiments can be used to practice the invention.

In one embodiment, the social contest application 30 and/or the server social contest application 30a includes a real-time push message 35 (i.e., information sent proactively, etc.) notification component allowing the social contest application 30 or the server social contest application 30a to push 35 electronic information to first target network 12 device, the pre-determined group of target network devices 14, 16, 29, 31 and/or other target network devices 98-104 outside of the pre-determined group of target network devices 14, 16, 29, 31 in real-time when desired social contest 13 is active. However, the present invention is not limited to such embodiments and other embodiments can be used to practice the invention.

In one embodiment, the social contest application 30 includes a user interface 126 allowing selection inputs to the desired social contest 13 with a swiping motion on a graphical user interface included on the social contest application 30. However, the present invention is not limited to such embodiments and other embodiments can be used to practice the invention.

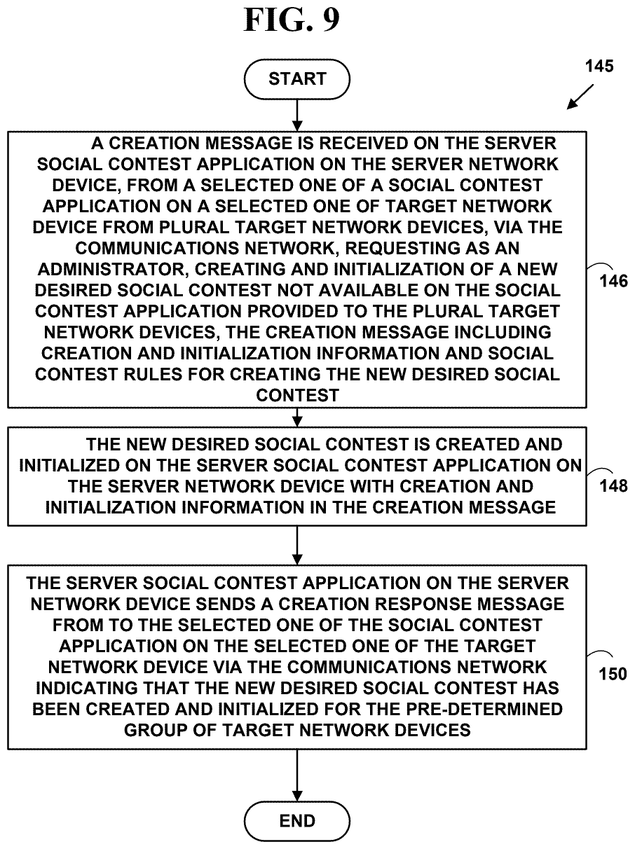

FIG. 9 is a flow diagram illustrating a Method 145 for providing social contests. At Step 146, a creation message is received on the server social contest application on the server network device, from a selected one of a social contest application on a selected one of target network device from plural target network devices, via the communications network, requesting as an administrator, creating and initialization of a new desired social contest not available on the social contest application provided to the plural target network devices, the creation message including creation and initialization information and social contest rules for creating the new desired social contest. At Step 148, the new desired social contest is created and initialized on the server social contest application on the server network device with creation and initialization information in the creation message. At Step 150, the server social contest application on the server network device sends a creation response message from to the selected one of the social contest application on the selected one of the target network device via the communications network indicating that the new desired social contest has been created and initialized for the pre-determined group of target network devices.

The present invention is illustrated with an exemplary embodiment. However, the present invention is not limited to such an embodiment and other embodiments can be used to practice the invention.

In such an exemplary embodiment in FIG. 9 at Step 146, a creation message is received on the server social contest application 30a on the server network device 20, from a selected one of a social contest application 30 on a selected one of target network device 12 from plural target network devices 14, 16, 29, 31, 98,104 via the communications network 18, requesting as an administrator, creating and initialization of a new desired social contest 13a not available on the social contest application provided to the plural target network devices 14, 16, 29, 31, 98,104, the creation message including creation and initialization information and social contest rules for creating the new desired social contest.

At Step 148, the new desired social contest 13a is created and initialized on the server social contest application 30a on the server network device 20 with creation and initialization information in the creation message.

At Step 150, the server social contest application 30a on the server network device 20 sends a creation response message from to the selected one of the social contest applications 30 on the selected one of the target network devices 12 via the communications network 18 indicating that the new desired social contest 13a has been created and initialized for the pre-determined group of target network devices 14, 16, 29, 31, 98,104.

In one embodiment, Method 145 is executed with a selection input to a NEW CONTEST graphical button 142 (FIG. 8) on the graphical user interface 126 on the selected one of the social contest applications 30 on the selected one of the target network devices 12. However, the present invention is not limited to such and embodiment and other embodiments can be used to practice the invention.

In one embodiment, the server network device 20 further includes a cloud server network device 20a with plural cloud applications 13/82, 15/82 and one or more cloud databases 20a′ communicating with a cloud communications network 18a, the plural cloud applications providing a plural social contest services including: a cloud computing Infrastructure as a Service (IaaS) 68, a cloud computing Platform as a Service (PaaS) 71 and social contest functionality as a Software as a Service (SaaS) 64. However, the present invention is not limited to such embodiments and other embodiments can be used to practice the invention, without and/or without a cloud communications network.

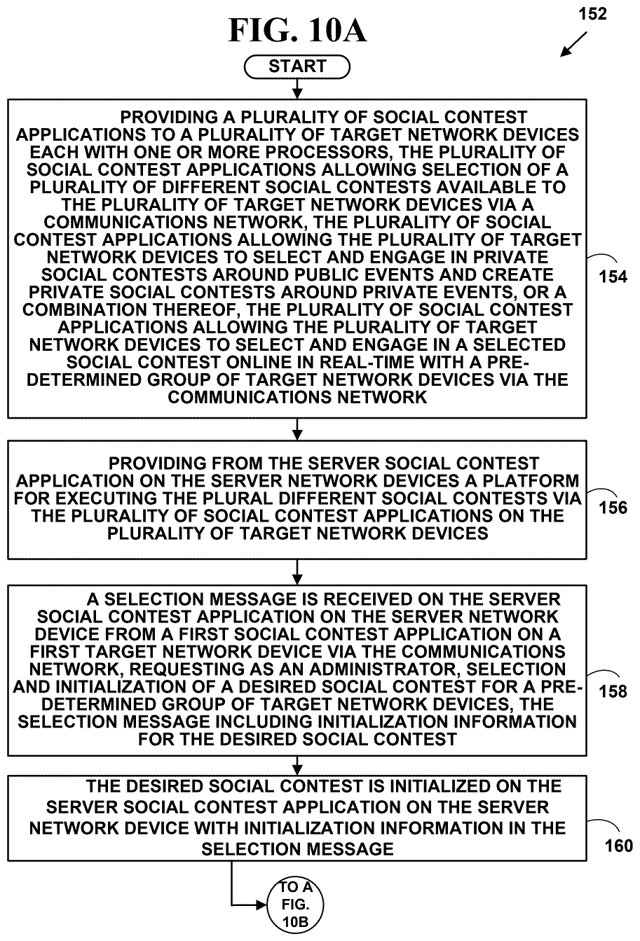

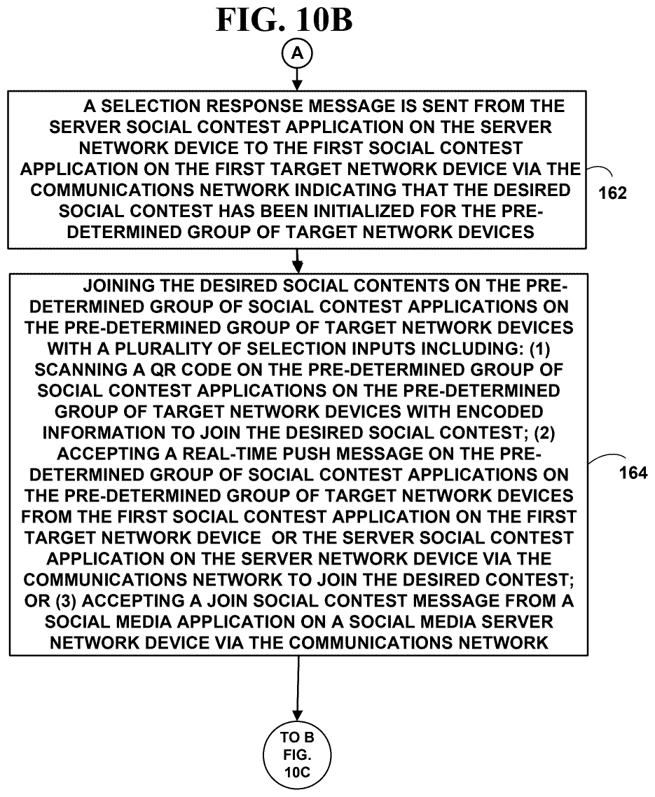

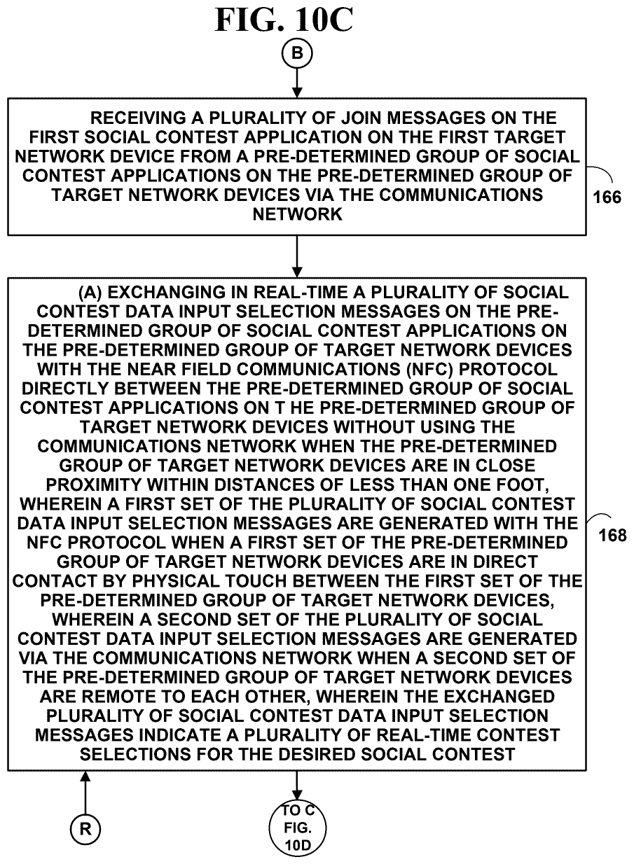

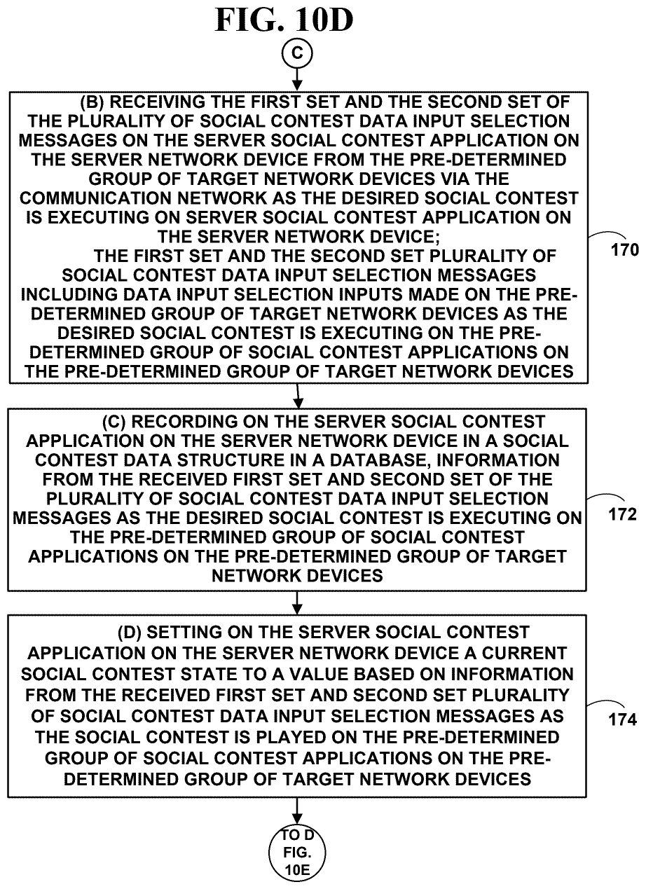

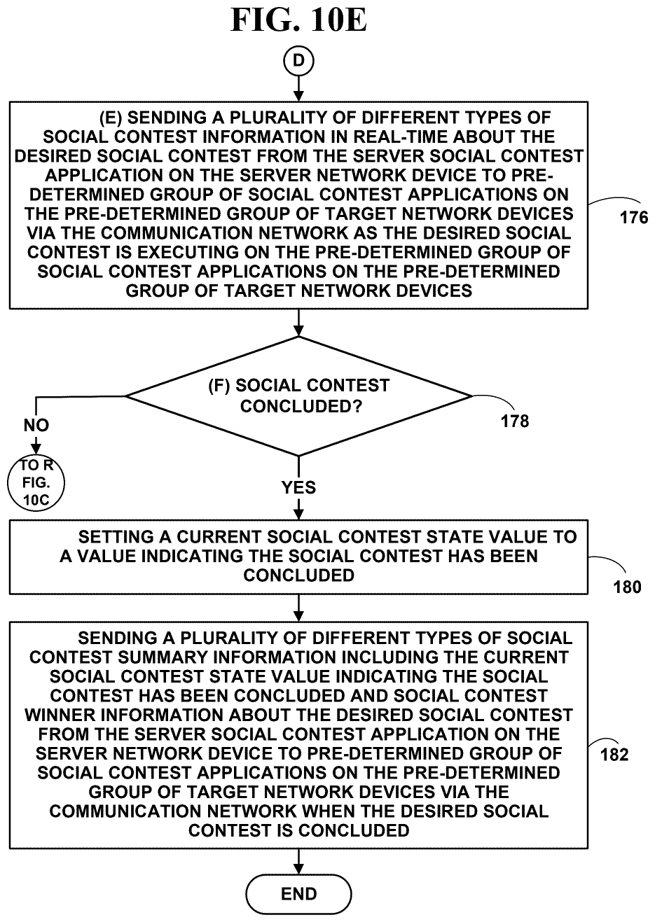

FIGS. 10A-10E are a flow diagram illustrating a Method 152 for providing social contests.

In FIG. 10A at Step 154, providing a plurality of social contest applications from a server social contest application on a server network device with one or more processors via a communications network to a plurality of target network devices each with one or more processors, the plurality social contest applications allowing selection of a plurality of different social contests available to the plurality of target network devices via the communications network, the plurality of social contest applications allowing the plurality of target network devices to create private social contests around public events and to select and engage private social contests around private events, or a combination thereof, the plurality of social contest applications allowing the plurality of target network devices to select and engage in a desired social contest online in real-time with a pre-determined group of target network devices via the communications network. At Step 156, the server social contest application on the server network device provides a platform for executing the plural different social contests via the plurality of social contest applications on the plural target network devices. At Step 158, a selection message is received on the server social contest application on the server network device from a first social contest application on a first target network device via the communications network, requesting as an administrator, selection and initialization of the desired social contest for a pre-determined group of target network devices. The selection message including initialization information for the desired social contest. At Step 160, the desired social contest is initialized on the server social contest application on the server network device with initialization information in the selection message. In FIG. 10B, at Step 162, a selection response message is sent from the server social contest application on the server network device to the first social contest application on the first target network device via the communications network indicating that the desired social contest has been initialized for the pre-determined group of target network devices. At Step 164, joining the desired social contents on the pre-determined group of social contest applications on the pre-determined group of target network devices with a plurality of selection inputs including: (1) scanning a QR code on the pre-determined group of social contest applications on the pre-determined group of target network devices with encoded information to join the desired social contest; (2) accepting a real-time push message on the pre-determined group of social contest applications on the pre-determined group of target network devices from the first social contest application on the first target network device or the server social contest application on the server network device via the communications network to join the desired contest; or (3) accepting a join social contest message from a social media application on a social media server network device via the communications network. In FIG. 10C at Step 166, receiving a plurality of join messages on the first social contest application on the first target network device from plurality of social contest data input selection messages on a pre-determined group of social contest applications on the pre-determined group of target network devices via the communications network. At Step 168, (a) exchanging in real-time a plurality of social contest data input selection messages on the pre-determined group of social contest applications on the pre-determined group of target network devices with a Near Field Communications (NFC) protocol directly between the pre-determined group of social contest applications on the pre-determined group of target network devices without using the communications network when the pre-determined group of target network devices are in close proximity within distances of less than one foot, wherein a first set of the plurality of social contest data input selection messages are generated with the NFC protocol when a first set of the pre-determined group of target network devices are in direct contact by physical touch between the first set of the pre-determined group of target network devices, wherein a second set of the plurality of social contest data input selection messages are generated via the communications network when a second set of the pre-determined group of target network devices are remote to each other, wherein the exchanged plurality of social contest data input selection messages indicate a plurality of real-time contest selections for the desired social contest. In FIG. 10D, at Step 170, (b) receiving the first set and the second set of the plurality of social contest data input selection messages on the server social contest application on the server network device from the pre-determined group of target network devices via the communication network as the desired social contest is executing on server social contest application on the server network device. At Step 172, (c) recording on the server social contest application on the server network device in a social contest data structure in a blockchain, information from the received first set and second set of the plurality of social contest data input selection messages as the desired social contest is executing on the pre-determined group of social contest applications on the pre-determined group of target network devices. At Step 174, (d) setting on the server social contest application on the server network device a current social contest state to a value based on information from the received first set and second set plurality of social contest data input selection messages as the social contest is played on the pre-determined group of social contest applications on the pre-determined group of target network devices. In FIG. 10E, at Step 176, (e) sending a plurality of different types of social contest information in real-time about the desired social contest from the server social contest application on the server network device to pre-determined group of social contest applications on the pre-determined group of target network devices via the communication network as the desired social contest is executing on the pre-determined group of social contest applications on the pre-determined group of target network devices. At Step 180, conducting a test on the server social contest application on the server network device with the current social contest state value from the created social contest data structure if the desired social contest has concluded, and if so setting the current social contest state value to a value indicating the social contest has been concluded and go to Step 182, and if not, go to FIG. 10C, Step 168 and repeating steps (a) through (f) until the created current social contest state value indicates that the desired social contest has concluded. At Step 182, sending a plurality of different types of social contest summary information and social contest winner information about the desired social contest from the server social contest application on the server network device to pre-determined group of social contest applications on the pre-determined group of target network devices via the communication network when the desired social contest is concluded.

The present invention is illustrated with an exemplary embodiment. However, the present invention is not limited to such an embodiment and other embodiments can be used to practice the invention.

In such an exemplary embodiment in FIG. 10A at Step 154, a plurality of social contest applications 30 are provided to a plurality of target network devices 12, 14, 16, 29, 31, 98-104 each with one or more processors. The plurality of social contest applications 30 allowing selection of a plural different social contests 13, 15 (only two of which are illustrated for simplicity) available to the plurality of target network devices 12, 14, 16, 29, 31, 98-104 via a communications network 18, 18a. The plurality of social contest application 30 allowing the plural target network devices 12, 14, 16, 31, 98-104 to select and engage in private social contests around public events 13 and create private social contests around private events 15, or a combination thereof. The plurality of social contest applications 30 allowing the plurality target network devices 12, 14, 16, 29, 31, 98-104 to select and engage in a selected social contest (e.g., 13, etc.) online in real-time (e.g. within a few seconds, etc.) with a pre-determined group of target network devices 12, 14, 16, 29, 31, 98-104 via the communications network 18, 18a.

In one embodiment, the private social contests around public events 13 include private social contests around community events, current events, entertainment events, news events, political events, sporting events, weather events, or a combination thereof. However, the present invention is not limited to such embodiments and other embodiments can be used to practice the invention.

In one embodiment, the private social contests around private events 15 includes but is not limited to, professional events or personal events, or a combination thereof, for employees of a company. However, the present invention is not limited to such embodiments and other embodiments can be used to practice the invention.

In one embodiment, the plural different social contests available 13,15 on the social contest application 30 includes, but is not limited to, a plural social gaming contests around public event and/or private events, and/or a combination thereof. However, the present invention is not limited to such embodiments and other embodiments can be used to practice the invention.

In one embodiment, the server social contest application 30a and/or the plurality of social contest applications 30 include, but are not limited to, a business-2-business (B2B) application. B2B refers to commercial transactions and interactions between two or more businesses. It is a process where one business sells products, services, or information to another business, rather than directly to individual consumers. In such an embodiment, the plurality of different social contests 13, 15 are played between businesses instead of individual players. However, the present invention is not limited to such an embodiment and other embodiments can be used to practice the invention.

At Step 156, a server social contest application 30a on a server network device (e.g. 20, etc.) with one or more processors provides a platform for executing the plurality of different social contests 13, 15 via the plurality of social contest applications 30 on the plural target network devices 12, 14, 16, 29, 31, 98-104.

At Step 158, a selection message is received on the server social contest application 30a on the server network device 20 from a first social contest application 30f on a first target network device 12 via the communications network 18, 18a requesting as an administrator, selection and initialization of a desired social contest 13 for a pre-determined group of target network devices (e.g., 14, 16, 29, 31, 98-104, etc.) The selection message including initialization information for the desired social contest 13.

At Step 160, the desired social contest 13 is initialized on the server social contest application 30a on the server network device 20 with initialization information in the selection message.

In FIG. 10C at Step 162, a selection response message is sent from the server social contest application 30a on the server network device 20, 20a to the first social contest application 30f on the first target network device 12 via the communications network 18,18a indicating that the desired social contest 13 has been initialized for the pre-determined group of target network devices 14, 16, 29, 31, 98-104.

At Step 164, joining the desired social contents on the pre-determined group of social contest applications 30 on the pre-determined group of target network devices 14, 16, 29, 31, 98-104 with a plurality of selection inputs including: (1) scanning a QR code 43 on the pre-determined group of social contest applications 30 on the pre-determined group of target network devices 14, 16, 29, 31 with encoded information to join the desired social contest 13; (2) accepting a real-time push message 35 on the pre-determined group of social contest applications 30 on the pre-determined group of target network devices 14, 16, 29, 31, 98-104 from the first social contest application 30f on the first target network device 12 or the server social contest application 30a on the server network device 20 via the communications network 18, 18a to join the desired contest 13; or (3) accepting a join social contest message from a social media application 45 on a social media server network device 24 via the communications network 18, 18a.

In one embodiment, the real-time push message 35 is automatically generated when the pre-determined group of target network devices 14, 16, 29, 31, 98-104 enters a geofence in a desired physical location. A geofence is a virtual boundary, like an invisible fence, created around a real-world location using Global Positioning System (GPS) and/or other location technologies (e.g., Wi-Fi, etc.). When a device enters or exits this virtual boundary, it can trigger automated actions or notifications. Essentially, geofencing combines location data with conditional logic to automate responses based on a device's proximity to a defined area. In another embodiment, the real-time push message 35 is generated by the first social contest application 30f on the first target network device 12 and/or the server social contest application 30a on the server network device 20, 20a. However, the present invention is not limited to such embodiments and other embodiments may be used to practice the invention.

In one embodiment, the social media application 45 on a social media server network device 24 includes X, FACEBOOK, INSTAGRAM, LINKEDIN, etc. and/or a personal social media account for a social media influencer. A social media influencer is someone who has built a strong online presence and credibility on social media platforms, allowing them to influence the opinions and purchasing decisions of their audience. They achieve this through creating and sharing content that resonates with their followers, establishing a strong brand, and engaging with their community. Influencers often partner with brands to promote products or services, generating income through sponsored content and other monetization strategies. However, the present invention is not limited to such embodiments and other embodiments may be used to practice the invention

In one embodiment, the QR code 43 a static and/or dynamic QR code 43 defined by ISO/IEC 18004:2015. This standard defines the requirements for the symbology known as a QR Code. It specifies the QR Code symbology characteristics, data character encoding methods, symbol formats, dimensional characteristics, error correction rules, reference decoding algorithm, production quality requirements, and user-selectable application parameters. The ISO/IEC 18004:2015 standard for QR codes is incorporated herein by reference. However, the present invention is not limited to such embodiments and embodiments can be used to practice the invention.

Static QR codes 43 include, but are not limited to: (1) a one-time purpose code; (2) limited data storage in the code; and (3) provides electronic links to email addresses, Uniform Resource Locators (URLs), electronic text, WiFi passwords, social media links, etc. However, the present invention is not limited to such embodiments and embodiments can be used to practice the invention.

Dynamic QR codes 43 are QR codes that are modifiable in content and can store more data than static QR codes. Dynamic QR codes enable access to real-time activation monitoring and/or determining locations of Dynamic QR code 43 activations made. However, the present invention is not limited to such embodiments and embodiments can be used to practice the invention.

Dynamic QR codes 43 include, but are not limited to the following features: (1) multifunctional QR codes for multiple URL directories; (2) editable and provides the ability to create and/or remove URLs even if your QR code has been printed and or deployed; (2) uses short dynamic URLs in storing data online; (3) QR code activations are trackable so users can see their QR analytics results; (4) allow analytics integration; (5) provide a password protection feature; (6) provide an email notification feature; (7) provide a time expiration feature; (8) allow integration into other non-cloud and cloud applications and cloud services; and (9) provide an API integration feature. However, the present invention is not limited to such embodiments and embodiments can be used to practice the invention.

There are typically four levels of QR code error correction used. The highest level, stores enough backup data to maintain QR code 43 functionality with up to 30% QR code damage. By using a lower level of error correction, less data modules are taken up for storage. The QR code 43 can safely decrease in size. However, the present invention is not limited to such embodiments and embodiments can be used to practice the invention.

The decoding information in QR code 43 includes decoding information for scanning the QR code 43. A QR code 43 typically needs about 10:1 distance-to-size ratio for accurate scanning. The size of the QR code 43 depends on the number of characters encoded in the QR code 43.

There are currently about 40 versions of the QR code framework. Version 2 is 25 data modules wide×25 data modules high. Data modules are the little black and white squares that make up QR codes. Version 37 is 165×165. Each version has a higher information capacity than the previous version. The amount of data in a QR code 43 affects its distance-to-size ratio scanning distance. However, the present invention is not limited to such embodiments and embodiments can be used to practice the invention.

TABLE 4

| | | Alphanumeric | 6″ Scan | 12″ Scan | 18″ Scan |
|---|---|---|---|---|---|
| Version | Modules | Characters | Distance | Distance | Distance |
| 2 | 25 × 25 | 47 | 0.6″ | 1.2″ | 1.8″ |
| 7 | 45 × 45 | 224 | 1.0″ | 2.0″ | 3.0″ |
| 17 | 85 × 85 | 938 | 1.8″ | 3.6″ | 5.4″ |
| 27 | 125 × 125 | 2132 | 2.5″ | 5.0″ | 7.4″ |
| 37 | 165 × 165 | 3729 | 3.3″ | 6.6″ | 13.4″ |

In FIG. 10C at Step 166, receiving a plurality of join messages on the first social contest application 30f on the first target network device 12 from the on a pre-determined group of social contest applications 30 on the pre-determined group of target network devices 14, 16, 29, 31 via the communications network 18, 18a.

At Step 168, (a) exchanging in real-time a plurality of social contest data input selection messages on the pre-determined group of social contest applications 30 on the pre-determined group of target network devices 14, 16, 29, 31, 98-104 with a Near Field Communications (NFC) protocol 185 directly between the pre-determined group of social contest applications 30 on the pre-determined group of target network devices 14, 16, 29, 31, 98-104 without using the communications network 18, 18a when the pre-determined group of target network devices 14, 16, 29, 31, 98-104 are in close proximity within distances of less than one foot, wherein a first set of the plurality of social contest data input selection messages are generated with the NFC protocol 185 when a first set of the pre-determined group of target network devices 14, 16 are in direct contact by physical touch between the first set of the pre-determined group of target network devices 14, 16, wherein a second set of the plurality of social contest data input selection messages are generated via the communications network 18, 18a when a second set of the pre-determined group of target network devices 14r, 16r are remote to each other, wherein the exchanged plurality of social contest data input selection messages indicate a plurality of real-time contest selections for the desired social contest 13.

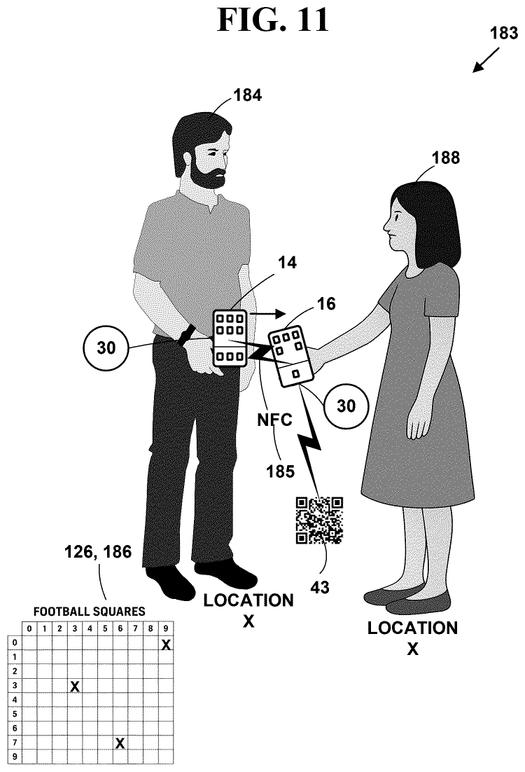

FIG. 11 is a block diagram 183 illustrating exchange of social contest information via a Near Field Communications (NFC) protocol 185.

In FIG. 11, a first social game player 184 sends his electronic social contest card including football squares (F) 126, 186 to a second social game player 188 via the NFC protocol 185 (i.e., via the first set of the plurality of social contest data input selection messages, etc.). In such an embodiment, the first social game player's 184 target network device 12 is in close proximity (i.e., one foot or less, etc.) and/or in direct contact touching (e.g., at Location X) the second social game player's 188 target network device 14 (e.g., also at Location X). The second social game player's 188 receives (i.e., via the first set of the plurality of social contest data input selection messages, etc.) the a first social game player 184 electronic social contest card 126, 186 including football squares (F′) on her target network device 14.

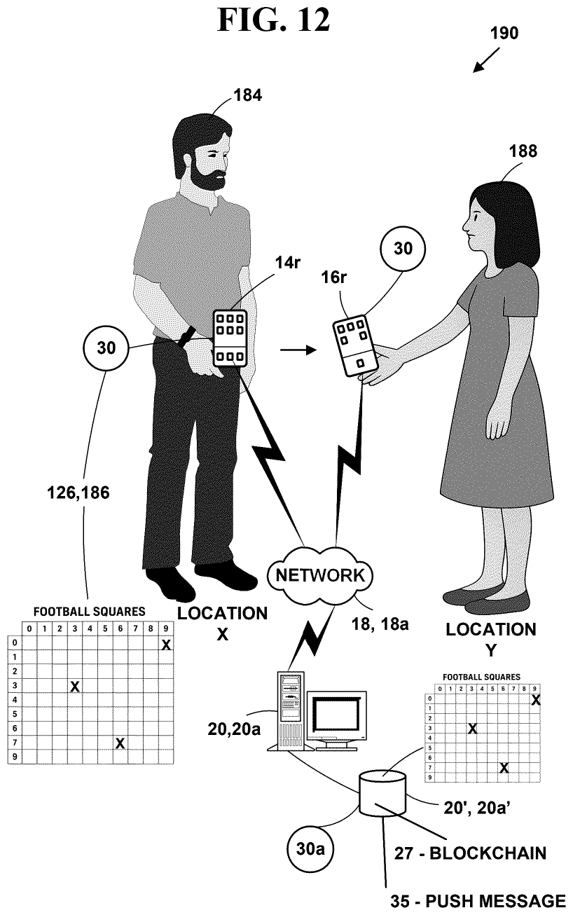

FIG. 12 is a block diagram 190 illustrating exchange of social contest information via a communications network 18, 18a.

In FIG. 12, the first social game player 184 sends his electronic social contest card including football squares (F) 126, 186 to a second social game player 188 via the communications network 18, 18a (i.e., via the second set of the plurality of social contest data input selection messages, etc.). In such an embodiment, the first social game player's 184 target network device 12r is remote (e.g., Location X, etc.) to the second social game player 188 (e.g., Location Y, etc.) and not at close proximity (i.e., one foot or less, etc.) and/or in direct contact touching the second social game player's 188 target network device 14r. The second social game player's 188 receives (i.e., via the second set of the plurality of social contest data input selection messages, etc.) the a first social game player 184 electronic social contest card 126, 186 including football squares (F′) on her target network device 14r via the communications network 18, 18a.

Returning now FIG. 10D, at Step 170, (b) receiving the first set and the second set of the plurality of social contest data input selection messages on the server social contest application 30a on the server network device 20, 20a from the pre-determined group of target network devices 12, 14, 16, 29, 31, 98-104 via the communication network 18, 18a as the desired social contest 13 is executing on server social contest application 30a on the server network device 20.

At Step 172, (c) recording (e.g., FIG. 12) on the server social contest application 30a on the server network device in a social contest data structure 47 (FIG. 1) in a blockchain 27 (e.g., FIG. 1, FIG. 12) information from the received first set and second set of the plurality of social contest data input selection messages as the desired social contest 13 is executing on the pre-determined group of social contest applications 30 on the pre-determined group of target network devices 12, 14, 16, 29, 31, 98-104.

The social contest data structure 47, includes, but is not limited to, an XML data structure with a plurality of fields including an individual data field for: (1) a current social contest state value; (2) a squares pools social gaming contest 128, (3) a Money Line Pick'Em 144 social gaming contest; and (4) a plurality of other social contests. However, the present invention is not limited to such an embodiment and other data structures with other data fields may be used to practice the invention.

A blockchain 27 includes, but is not limited to, a public ledger of all transactions that have ever been executed. It is constantly growing as completed blocks are added to it with a new set of recordings. The blocks are added to the blockchain in a linear, chronological order. Blockchains are used on Peer-2-Peer (P2P) networks and other networks such as cloud communications networks. Each P2P node gets a copy of the blockchain, which gets downloaded automatically upon joining P2P. The blockchain has complete information about the block owners and block content right from the first block to the most recently completed block.

A blockchain 27 is also a digital ledger that records every transaction that has ever occurred. Blockchains and transactions on blockchains are typically protected by cryptography. More importantly, though, the blockchain does not reside in a single server, but across a distributed network of servers and computer such as a cloud computing network and a P2P computing network. Accordingly, whenever new transactions occur, a new blockchain is authenticated across this distributed network, then the transaction is included as a new “block” on the “chain.” A block chain implementation comprises of two kinds of records: transactions and blocks.

Transactions are the content to be stored in the block chain (e.g., financial transactions, etc.). Transactions are created by participants using the system. In the case of cryptocurrencies, a transaction is created any time a cryptocurrency owner sends cryptocurrency to someone.

A transaction is also a transfer of value between digital wallets that gets included in the block chain. Digital wallets store a secret piece of data called a private key or, which is used to digitally sign transactions, providing a mathematical proof that the digital signature has actually come from the owner of the digital wallet.

System users create transactions that are passed from node to node on a best-effort basis. The system implementing the blockchain defines a valid transaction. In cryptocurrency applications, a valid transaction must be digitally signed, spend one or more unspent outputs of previous transactions, and the sum of transaction outputs must not exceed the sum of inputs.

Blocks record and confirm when and in what sequence transactions enter and are logged in the block chain. Blocks are created by users known as “miners” who use specialized software or equipment designed specifically to create blocks.

Blockchains are decentralized and do not require a central authority or “middleman.” Every node in a decentralized system has a copy of the block chain. This avoids the need to have a centralized database managed by a trusted third party. Blockchain transactions are broadcast to a network using software applications. Network nodes can validate transactions, add them to their copy and then broadcast these additions to other nodes. To avoid the need for a trusted third party to timestamp transactions, decentralized block chains use various timestamping schemes, such as proof-of-work.

The core advantages of the blockchain architecture include, but are not limited to those described in Table 5.

TABLE 5
The ability for independent nodes to converge on a consensus of the
latest version of a large data set such, as a ledger, even when the nodes
are run anonymously, have poor interconnectivity and have operators
who are dishonest or malicious.
The ability for any well-connected node to determine, with
reasonable certainty, whether a transaction does or does not exist in the
data set.
The ability for any node that creates a transaction to, after a
confirmation period, determine with a reasonable level of certainty
whether the transaction is valid, able to take place and become final (i.e.,
that no conflicting transactions were confirmed into the block chain
elsewhere that would invalidate the transaction, such as the same
currency units “double-spent” somewhere else).
A prohibitively high cost to attempt to rewrite or alter transaction
history.
Automated conflict resolution that ensures that conflicting
transactions (such as two or more attempts to spend the same balance in
different places) never become part of the confirmed data set.

In one embodiment, the blockchain 27 is replaced with cloud storage objects 82 stored in a cloud database 20′a. However, the present invention is not limited to such an embodiment and other embodiments can be used to practice the invention.

At Step 174, (d) setting on the server social contest application 30a on the server network device 20, 20a a current social contest state to a value based on information from the received first set and second set plurality of social contest data input selection messages as the desired social contest 13 is played on the pre-determined group of social contest applications 30 on the pre-determined group of target network devices 12, 14, 16, 29, 31, 98-104.

In FIG. 10D, at Step 176, (e) sending a plurality of different types of social contest information in real-time about the desired social contest 13 from the server social contest application 30a on the server network device 20, 20a to the pre-determined group of social contest applications 30 on the pre-determined group of target network devices 12, 14, 16, 29, 31, 98-104 via the communication network 18, 18a as the desired social contest 13 is executing on the pre-determined group of social contest applications 30 on the pre-determined group of target network devices 12, 14, 16, 29, 31, 98-104.

At Step 178, (f) conducting a test on the server social contest application 30a on the server network device 20, 20a with the current social contest state value from created social contest data structure 47 if the desired social contest has concluded, and if so, setting the current social contest state value to a value indicating the desired social contest 13 has been concluded and go to Step 182, and if not, go to FIG. 10C, Step 168 and repeating steps (a) through (f) (Steps 168-178) until the created current social contest state value indicates that the desired social contest 13 has concluded.

At Step 182, sending a plurality of different types of social contest summary information 21 and social contest winner information 23 about the desired social contest from the server social contest application 30a on the server network device 20, 20a to pre-determined group of social contest applications 30 on the pre-determined group of target network devices 12, 14, 16, 29, 31, 98-104 via the communication network 18, 18a when the desired social contest 13 is concluded.

A method and system for social contests is presented. The method and system include an application for social contests that allows new social contests to be created for private and public groups of people. An administrator of a social contest creates a unique new social contest or selects from plural pre-determined social contests. Participants join the social contests with a QR code, a push message or an invite from a social media site. Participants in the social contest invite their friends to participate in the social contest and participants can message each other directly during the social contest. A graphical user interface is presented on the application to allow creation and administration of the social contests.

It should be understood that the architecture, programs, processes, methods and systems described herein are not related or limited to any particular type of computer or network system (hardware or software), unless indicated otherwise. Various types of computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended. Therefore, all embodiments that come within the scope and spirit of the following claims and equivalents thereto are claimed as the invention.

I claim:

1. A method for providing social contests, comprising:
providing a plurality of social contest applications via a server social contest application on a server network device with one or more processors, to a plurality of target network devices each with one or more processors, via a communications network;
the plurality of social contest applications allowing selection of a plurality of different social contests available to the plurality of target network devices via the communications network,
the plurality of social contest applications allowing the plurality of target network devices to select and engage in private social contests around public events and create private social contests around private events, or a combination thereof,
the plurality of social contest applications allowing the plurality of target network devices to select and engage in a selected social contest online in real-time with a pre-determined group of target network devices via the communications network;
providing on the server social contest application on the server network device, a platform for executing the plurality of different social contests via the plurality of social contest applications on the plurality of target network devices;
receiving a selection message on the server social contest application on the server network device from a first social contest application on a first target network device with one or more processors via the communications network, requesting as an administrator, selection and initialization of a desired social contest for a pre-determined group of target network devices;
the selection message including initialization information for the desired social contest;
initializing the desired social contest on the server social contest application on the server network device with initialization information in the selection message;
sending a selection response message from the server social contest application on the server network device to the first social contest application on the first target network device via the communications network indicating that the desired social contest has been initialized for the pre-determined group of target network devices;
joining the desired social contest on a pre-determined group of social contest applications on the pre-determined group of target network devices with a plurality of selection inputs including: (1) scanning a QR code on the pre-determined group of social contest applications on the pre-determined group of target network devices with encoded information to join the desired social contest; (2) accepting a real-time push message on the pre-determined group of social contest applications on the pre-determined group of target network devices from the first social contest application on the first target network device or the server social contest application on the server network device via the communications network to join the desired contest; or (3) accepting a join social contest message from a social media application on a social media server network device via the communications network;
receiving a plurality of join messages on the first social contest application on the first target network device from the pre-determined group of social contest applications on the pre-determined group of target network devices via the communications network;
(a) exchanging in real-time the plurality of social contest data input selection messages on a pre-determined group of social contest applications on the pre-determined group of target network devices with a Near Field Communications (NFC) protocol directly between the pre-determined group of social contest applications on the pre-determined group of target network devices without using the communications network when the pre-determined group of target network devices are in close proximity within distances of less than one foot,
wherein a first set of the plurality of social contest data input selection messages are generated with the NFC protocol when a first set of the pre-determined group of target network devices are in direct contact by physical touch between the first set of the pre-determined group of target network devices,
wherein a second set of the plurality of social contest data input selection messages are generated via the communications network when a second set of the pre-determined group of target network devices are remote to each other,
wherein the exchanged plurality of social contest data input selection messages indicate a plurality of real-time contest selections for the desired social contest;
(b) receiving the first set and the second set of the plurality of social contest data input selection messages on the server social contest application on the server network device from the pre-determined group of target network devices via the communication network as the desired social contest is executing on server social contest application on the server network device;
the first set and the second set plurality of social contest data input selection messages including data input selection inputs made on the pre-determined group of target network devices as the desired social contest is executing on the pre-determined group of social contest applications on the pre-determined group of target network devices;
(c) recording on the server social contest application on the server network device in a social contest data structure in a blockchain, information from the received first set and second set of the plurality of social contest data input selection messages as the desired social contest is executing on the pre-determined group of social contest applications on the pre-determined group of target network devices;
(d) setting on the server social contest application on the server network device a current social contest state to a value based on information from the received first set and second set plurality of social contest data input selection messages as the social contest is played on the pre-determined group of social contest applications on the pre-determined group of target network devices;
(e) sending a plurality of different types of social contest information in real-time about the desired social contest from the server social contest application on the server network device to pre-determined group of social contest applications on the pre-determined group of target network devices via the communication network as the desired social contest is executing on the pre-determined group of social contest applications on the pre-determined group of target network devices;
(f) conducting a test on the server social contest application on the server network device with the current social contest state value if the desired social contest has concluded,
and if not,
repeating steps (a) through (f) until the created current social contest state value indicates that the desired social contest has concluded,
and if so,
setting a current social contest state value to a value indicating the social contest has been concluded; and
sending a plurality of different types of social contest summary information including the current social contest state value indicating the social contest has been concluded and social contest winner information about the desired social contest from the server social contest application on the server network device to pre-determined group of social contest applications on the pre-determined group of target network devices via the communication network when the desired social contest is concluded.

2. The method of claim 1 wherein, the private social contests around public events include private social contests around community events, current events, entertainment events, news events, political events, pop culture events, sporting events, weather events, or a combination thereof.

3. The method of claim 1 wherein, the server social contest application and the plurality of social contest applications include a business-2-business (B2B) application.

4. The method of claim 1 wherein, the plurality of different social contests available on the social contest application include a plurality of social gaming contests around public events or private events, or a combination thereof and the private social contests around private events include professional events or personal events, or a combination thereof, for employees of a company.

5. The method of claim 4 wherein, the plurality of social gaming contests available on the social contest application include a money line pick'em social gaming contents, squares pools social gaming contests, or a combination thereof.

6. The method of claim 1 wherein, the plurality of social gaming contests available on the social contest application include a plurality of pre-determined templates for pre-determined game slates including a list of a plurality of games scheduled to be played on a pre-determined day at a pre-determined time.

7. The method of claim 1 wherein, the plurality of social contests include selecting a game for picking an intermittent score or final score of a sporting event, picking answers to questions created for entertainment, sports, politics, pop culture weather or cultural events, picking a winner of a political election, or picking a date, time, date and time or an amount of an occurrence of a public event or private event, or a combination thereof.

8. The method of claim 1 wherein, the step of providing the plurality of different types of social contest information in real-time includes providing electronic social contest rules, social contest summaries, a social contest leaderboard or a summary of points earned for one or more social contests played, bonus picks and providing electronic information for current, upcoming and previously played social contests.

9. The method of claim 8 wherein, the summary of points are useable outside of the social contest application with other applications to obtain goods or services provided through the other applications.

10. The method of claim 1 wherein, the plurality of social contest applications includes one or more graphical buttons representing one or more featured social contests from the plurality of different social contests available to the plurality of target network devices.

11. The method of claim 1 wherein, the plurality of social contest applications further including:
a graphical SHARE button allowing the first target network device to share the desired social contest that has been selected on the first target network device and initialized via the server social contest application on the server network device via the communications network within the pre-determined group of target network devices, or other target network devices outside of the pre-determined group of target network devices,
wherein the SHARE button is active only after the desired social contest has been selected and initialized on the server social contest application on the server network device; and
a graphical INVITE button allowing first target network device and the desired group of network devices to invite other target network devices within the pre-determined group of target network devices, or other target network devices outside of the pre-determined group of target network devices, to participate in the desired social contest,
wherein the wherein the graphical INVITE button is active only after the desired social contest has been selected and initialized server social contest application on the server network device.

12. The method of claim 11 wherein initiating a selection of the graphical SHARE button or the graphical INVITE button on the first target network device includes, sending an email, SMS message, social media message, wireless message or automated voice mail message from the first target network device to the pre-determined group of target network devices or other target network devices outside of the pre-determined group of target network devices.

13. The method of claim 11 wherein initiating a selection of the graphical SHARE button or the graphical INVITE button on a selected one of the desired group of network devices includes, sending an email, SMS message, social media message, wireless message or automated voice mail message from the selected one of the desired group of network devices to the first target network device, other ones in the pre-determined group of target network devices or other target network devices outside of the pre-determined group of target network devices.

14. The method of claim 1 the server social contest application and the plurality of social contest applications include an artificial intelligence (AI) application for providing social contests, for playing social contests and predicting and anticipating outcomes of social contests.

15. The method of claim 1 wherein, the plurality of social contest applications include a real-time chat component allowing the first target network device, the pre-determined group of target network devices or other target network devices outside of the pre-determined group of target network devices, to communicate via the communications network in real-time when desired social contest is active.

16. The method of claim 1 wherein, the server network device further includes a cloud server network device with a plurality of cloud applications and one or more cloud databases communicating with a cloud communications network, the plurality of cloud applications providing a plurality of social contest services including: a cloud computing Infrastructure as a Service (IaaS), a cloud computing Platform as a Service (PaaS) and social contest functionality as a Software as a Service (SaaS).

17. The method of claim 1 wherein, the plurality of target network devices include: desktop computers, laptop computers, tablet computers, mobile phones, non-mobile phones, smart phones, personal digital/data assistants (PDA), portable game consoles, non-portable game consoles, wearable network devices, Internet of Things (IoT) devices, cable television (CATV) set-top boxes, satellite television boxes, or digital televisions including high-definition (HDTV) or three-dimensional (3D) televisions.

18. The method of claim 1 wherein, the plurality of target network devices and the server network device include one or more wireless communications interfaces comprising: cellular telephone, 802.11a, 802.11b, 802.11 g, 802.11n, 802.15.4 (ZigBee), Wireless Fidelity (Wi-Fi), Wi-Fi Aware, Worldwide Interoperability for Microwave Access (WiMAX), ETSI High Performance Radio Metropolitan Area Network (HIPERMAN), Near Field Communications (NFC), Machine-to-Machine (M2M), 802.15.1 (Bluetooth), or infra data association (IrDA), wireless communication interfaces, for communicating with the communications network.

19. A non-transitory computer readable have stored therein a plurality of instructions for causing one or more processors to execute the steps of:
providing a plurality of social contest applications via a server social contest application on a server network device with one or more processors, to a plurality of target network devices each with one or more processors, via a communications network;
the plurality of social contest applications allowing selection of a plurality of different social contests available to the plurality of target network devices via the communications network,
the plurality of social contest applications allowing the plurality of target network devices to select and engage in private social contests around public events and create private social contests around private events, or a combination thereof,
the plurality of social contest applications allowing the plurality of target network devices to select and engage in a selected social contest online in real-time with a pre-determined group of target network devices via the communications network;
providing on the server social contest application on the server network device, a platform for executing the plurality of different social contests via the plurality of social contest applications on the plurality of target network devices;
receiving a selection message on the server social contest application on the server network device from a first social contest application on a first target network device with one or more processors via the communications network, requesting as an administrator, selection and initialization of a desired social contest for a pre-determined group of target network devices;
the selection message including initialization information for the desired social contest;
initializing the desired social contest on the server social contest application on the server network device with initialization information in the selection message;
sending a selection response message from the server social contest application on the server network device to the first social contest application on the first target network device via the communications network indicating that the desired social contest has been initialized for the pre-determined group of target network devices;
joining the desired social contest on a pre-determined group of social contest applications on the pre-determined group of target network devices with a plurality of selection inputs including: (1) scanning a QR code on the pre-determined group of social contest applications on the pre-determined group of target network devices with encoded information to join the desired social contest; (2) accepting a real-time push message on the pre-determined group of social contest applications on the pre-determined group of target network devices from the first social contest application on the first target network device or the server social contest application on the server network device via the communications network to join the desired contest; or (3) accepting a join social contest message from a social media application on a social media server network device via the communications network;
receiving a plurality of join messages on the first social contest application on the first target network device from the pre-determined group of social contest applications on the pre-determined group of target network devices via the communications network;
(a) exchanging in real-time the plurality of social contest data input selection messages on a pre-determined group of social contest applications on the pre-determined group of target network devices with a Near Field Communications (NFC) protocol directly between the pre-determined group of social contest applications on the pre-determined group of target network devices without using the communications network when the pre-determined group of target network devices are in close proximity within distances of less than one foot,
wherein a first set of the plurality of social contest data input selection messages are generated with the NFC protocol when a first set of the pre-determined group of target network devices are in direct contact by physical touch between the first set of the pre-determined group of target network devices,
wherein a second set of the plurality of social contest data input selection messages are generated via the communications network when a second set of the pre-determined group of target network devices are remote to each other,
wherein the exchanged plurality of social contest data input selection messages indicate a plurality of real-time contest selections for the desired social contest;
(b) receiving the first set and the second set of the plurality of social contest data input selection messages on the server social contest application on the server network device from the pre-determined group of target network devices via the communication network as the desired social contest is executing on server social contest application on the server network device;
the first set and the second set plurality of social contest data input selection messages including data input selection inputs made on the pre-determined group of target network devices as the desired social contest is executing on the pre-determined group of social contest applications on the pre-determined group of target network devices;
(c) recording on the server social contest application on the server network device in a social contest data structure in a blockchain, information from the received first set and second set of the plurality of social contest data input selection messages as the desired social contest is executing on the pre-determined group of social contest applications on the pre-determined group of target network devices;
(d) setting on the server social contest application on the server network device a current social contest state to a value based on information from the received first set and second set plurality of social contest data input selection messages as the social contest is played on the pre-determined group of social contest applications on the pre-determined group of target network devices;
(e) sending a plurality of different types of social contest information in real-time about the desired social contest from the server social contest application on the server network device to pre-determined group of social contest applications on the pre-determined group of target network devices via the communication network as the desired social contest is executing on the pre-determined group of social contest applications on the pre-determined group of target network devices;
(f) conducting a test on the server social contest application on the server network device with the current social contest state value if the desired social contest has concluded,
and if not,
repeating steps (a) through (f) until the created current social contest state value indicates that the desired social contest has concluded,
and if so,
setting a current social contest state value to a value indicating the social contest has been concluded; and
sending a plurality of different types of social contest summary information including the current social contest state value indicating the social contest has been concluded and social contest winner information about the desired social contest from the server social contest application on the server network device to pre-determined group of social contest applications on the pre-determined group of target network devices via the communication network when the desired social contest is concluded.

20. A system for providing social contests, comprising in combination:
a server network device with one or more processors;
a plurality of target network devices each with one or more processors;
a communications network;
for providing a plurality of social contest applications via a server social contest application on a server network device with one or more processors, to a plurality of target network devices each with one or more processors, via a communications network;
the plurality of social contest applications allowing selection of a plurality of different social contests available to the plurality of target network devices via the communications network,
the plurality of social contest applications allowing the plurality of target network devices to select and engage in private social contests around public events and create private social contests around private events, or a combination thereof,
the plurality of social contest applications allowing the plurality of target network devices to select and engage in a selected social contest online in real-time with a pre-determined group of target network devices via the communications network;
for providing on the server social contest application on the server network device, a platform for executing the plurality of different social contests via the plurality of social contest applications on the plurality of target network devices;
for receiving a selection message on the server social contest application on the server network device from a first social contest application on a first target network device with one or more processors via the communications network, requesting as an administrator, selection and initialization of a desired social contest for a pre-determined group of target network devices;
the selection message including initialization information for the desired social contest;
for initializing the desired social contest on the server social contest application on the server network device with initialization information in the selection message;
for sending a selection response message from the server social contest application on the server network device to the first social contest application on the first target network device via the communications network indicating that the desired social contest has been initialized for the pre-determined group of target network devices;
for joining the desired social contest on a pre-determined group of social contest applications on the pre-determined group of target network devices with a plurality of selection inputs including: (1) scanning a QR code on the pre-determined group of social contest applications on the pre-determined group of target network devices with encoded information to join the desired social contest; (2) accepting a real-time push message on the pre-determined group of social contest applications on the pre-determined group of target network devices from the first social contest application on the first target network device or the server social contest application on the server network device via the communications network to join the desired contest; or (3) accepting a join social contest message from a social media application on a social media server network device via the communications network;
for receiving a plurality of join messages on the first social contest application on the first target network device from the pre-determined group of social contest applications on the pre-determined group of target network devices via the communications network;
for (a) exchanging in real-time the plurality of social contest data input selection messages on a pre-determined group of social contest applications on the pre-determined group of target network devices with a Near Field Communications (NFC) protocol directly between the pre-determined group of social contest applications on the pre-determined group of target network devices without using the communications network when the pre-determined group of target network devices are in close proximity within distances of less than one foot,
wherein a first set of the plurality of social contest data input selection messages are generated with the NFC protocol when a first set of the pre-determined group of target network devices are in direct contact by physical touch between the first set of the pre-determined group of target network devices,
wherein a second set of the plurality of social contest data input selection messages are generated via the communications network when a second set of the pre-determined group of target network devices are remote to each other,
wherein the exchanged plurality of social contest data input selection messages indicate a plurality of real-time contest selections for the desired social contest;
for (b) receiving the first set and the second set of the plurality of social contest data input selection messages on the server social contest application on the server network device from the pre-determined group of target network devices via the communication network as the desired social contest is executing on server social contest application on the server network device;
the first set and the second set plurality of social contest data input selection messages including data input selection inputs made on the pre-determined group of target network devices as the desired social contest is executing on the pre-determined group of social contest applications on the pre-determined group of target network devices;
for (c) recording on the server social contest application on the server network device in a social contest data structure in a blockchain, information from the received first set and second set of the plurality of social contest data input selection messages as the desired social contest is executing on the pre-determined group of social contest applications on the pre-determined group of target network devices;
for (d) setting on the server social contest application on the server network device a current social contest state to a value based on information from the received first set and second set plurality of social contest data input selection messages as the social contest is played on the pre-determined group of social contest applications on the pre-determined group of target network devices;
for (e) sending a plurality of different types of social contest information in real-time about the desired social contest from the server social contest application on the server network device to pre-determined group of social contest applications on the pre-determined group of target network devices via the communication network as the desired social contest is executing on the pre-determined group of social contest applications on the pre-determined group of target network devices;
for (f) conducting a test on the server social contest application on the server network device with the current social contest state value if the desired social contest has concluded,
and if not,
for repeating steps (a) through (f) until the created current social contest state value indicates that the desired social contest has concluded,
and if so,
for setting a current social contest state value to a value indicating the social contest has been concluded; and
for sending a plurality of different types of social contest summary information including the current social contest state value indicating the social contest has been concluded and social contest winner information about the desired social contest from the server social contest application on the server network device to pre-determined group of social contest applications on the pre-determined group of target network devices via the communication network when the desired social contest is concluded.
